(19) United States
(12) Patent Application Publication
(10) Pub. No.: US 2026/0319424 A1
(43) Pub. Date: Oct. 15, 2026

(54) CONVEYING APPARATUS

(71) Applicant: CANON KABUSHIKI KAISHA, Tokyo (JP)

(72) Inventors: SACHIYORI SHIINA, Shizuoka (JP); KO KATAHIRA, Kanagawa (JP)

(21) Appl. No.: 19/462,080

(22) Filed: Jan. 28, 2026

(30) Foreign Application Priority Data
Feb. 5, 2025 (JP) 2025-017967

(51) Int. Cl. G03G 15/00; B65H 29/16; G03G 21/16

(52) U.S. Cl. CPC G03G 15/6573; B65H 29/16; G03G 21/1647; B65H 2404/10; B65H 2404/539; B65H 2404/612; G03G 2221/1654

(57) ABSTRACT

A conveying apparatus includes: a main body frame including a first frame and a second frame; a conveying guide that is disposed between the first frame and the second frame in engagement with them and includes a first guiding member and a second guiding member; and a connecting member connecting the first guiding member and the second guiding member. The connecting member is less in thermal expansion coefficient than the first guiding member and the second guiding member. The connecting member is restricted from moving relative to the main body frame in a rotational axis direction of a conveying roller. The second guiding member is restricted from moving relative to the connecting member in the rotational axis direction.

### BACKGROUND

### Field of the Technology

The present disclosure relates to a conveying apparatus that conveys a recording material.

### DESCRIPTION OF THE RELATED ART

A conveying apparatus for conveying a recording material in an image recording apparatus includes a conveying roller configured to convey the recording material and a conveying guide configured to guide the recording material. In case of the conveying guide such as a double-sided flapper that is long in a rotational axis direction of the conveying roller and is thin in thickness, the conveying guide may undergo warping and deterioration in strength. Japanese Patent Application Laid-Open No. 2019-211659 discloses an art for suppressing warping of a conveying guide and ensuring strength of the conveying guide by forming the conveying guide with a plurality of components arranged in a rotational axis direction, and supporting the components with a metal shaft member extending along the rotational axis direction. In a conveying apparatus including a conveying roller that conveys a recording material and a conveying guide, thermal expansion and contraction of a plurality of members constituting the conveying guide may cause positions of the members to vary in a rotational axis direction of the conveying roller.

### SUMMARY

The present disclosure intends to improve positioning accuracy in a rotational axis direction of a plurality of components that constitute a conveying guide.

According to one aspect of the present disclosure, a conveying apparatus configured to convey a recording material includes:
a conveying roller configured to convey the recording material;
a main body frame that includes a first frame including a first engaging portion and a second frame including a second engaging portion;
a conveying guide arranged between the first frame and the second frame in a rotational axis direction of the conveying roller, the conveying guide including a first guiding member and a second guiding member configured to guide the recording material, and including a first engaged portion that engages with the first engaging portion and a second engaged portion that engages with the second engaging portion; and
a connecting member connecting the first guiding member and the second guiding member,
wherein:
the first guiding member and the second guiding member are arranged side by side in the rotational axis direction such that the first guiding member is closer to the first frame than to the second frame and the second guiding member is closer to the second frame than to the first frame in the rotational axis direction;
a thermal expansion coefficient of the connecting member is less than a thermal expansion coefficient of the first guiding member and less than a thermal expansion coefficient of the second guiding member;
where a first direction is a direction parallel to the rotational axis direction and oriented from the second frame toward the first frame, and a second direction is a direction opposite to the first direction,
the connecting member is restricted from moving relative to the main body frame in the first direction and in the second direction; and
the second guiding member is restricted from moving relative to the connecting member in the first direction and in the second direction.

According to another aspect of the present disclosure, a conveying apparatus configured to convey a recording material includes:
a conveying roller configured to convey the recording material;
a main body frame that includes a first frame including a first engaging portion and a second frame including a second engaging portion;
a conveying guide arranged between the first frame and the second frame in a rotational axis direction of the conveying roller, the conveying guide including a first guiding member and a second guiding member configured to guide the recording material, and including a first engaged portion that engages with the first engaging portion and a second engaged portion that engages with the second engaging portion; and
a connecting member connecting the first guiding member and the second guiding member,
wherein:
the first guiding member and the second guiding member are arranged side by side in the rotational axis direction such that the first guiding member is closer to the first frame than to the second frame and the second guiding member is closer to the second frame than to the first frame in the rotational axis direction;
where a first direction is a direction parallel to the rotational axis direction and oriented from the second frame toward the first frame, and a second direction is a direction opposite to the first direction,
the first engaging portion and the first engaged portion engage with each other to restrict the first guiding member from moving relative to the first frame in the second direction; and
the second engaging portion and the second engaged portion engage with each other to restrict the second guiding member from moving relative to the second frame in the first direction.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a configuration of an image forming apparatus according to an embodiment.

FIG. 2 is a diagram showing a conveying path from a fixing portion to an upstream side of a paper discharge roller of the image forming apparatus according to the embodiment.

FIG. 3 is a front view of a conveying guide according to a first embodiment.

FIG. 4 is a sectional view of the conveying guide according to the first embodiment.

FIG. 5 is a front view of a conveying guide according to a second embodiment.

FIG. 6 is a sectional view of the conveying guide according to the second embodiment.

FIG. 7 is a perspective view of a conveying guide according to a modification of the second embodiment.

FIG. 8 is an exploded perspective view of the conveying guide according to the modification of the second embodiment.

FIG. 9 is a sectional view of a conveying guide according to a third embodiment.

FIG. 10 is a sectional view of a conveying guide according to a fourth embodiment.

FIG. 11 is a sectional view of a conveying guide according to a fifth embodiment.

FIG. 12 is a sectional view of a conveying guide according to a sixth embodiment.

FIG. 13 is a sectional view of a conveying guide according to a seventh embodiment.

### DESCRIPTION OF THE EMBODIMENTS

Hereinafter, exemplary embodiments for implementing the present disclosure will be described with reference to the drawings. However, it is to be understood that dimensions, materials, shapes, relative arrangements, and the like of components described in the following embodiments are intended to be changed as deemed appropriate in accordance with configurations and various conditions of apparatuses to which the present disclosure is to be applied and are not intended to limit the scope of the present disclosure to the embodiments described below. Configurations of the conveying guides disclosed herein are not limited to the respective embodiments. Characteristic components of the respective embodiments can be mutually combined within the scope of the present disclosure to the greatest extent feasible.

### Image Forming Apparatus

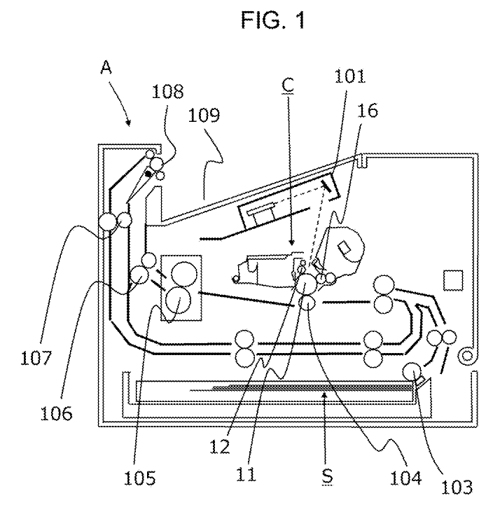

FIG. 1 is a diagram showing an overall configuration of an image forming apparatus 1 according to an embodiment. The image forming apparatus 1 is a monochrome laser beam printer which forms an image on a sheet S that is a recording material using an electrophotographic process. A cartridge C is attachable/detachable to/from an apparatus main body A of the image forming apparatus 1. The apparatus main body A includes a laser scanner 101, a feeding roller 103, a transfer roller 104, a fixing portion 105, a conveying roller 106, a paper discharge roller 108, and a paper discharge tray 109. The cartridge C includes a photosensitive drum 11, a charging roller 12, and a developing roller 16. In the following description, a rotational axis direction of the conveying roller 106 may be simply referred to as the rotational axis direction. The rotational axis direction and a width direction of the sheet S are parallel to each other while the rotational axis direction and a conveying direction of the sheet S are orthogonal to each other.

An operation of the image forming apparatus 1 will now be described. The photosensitive drum 11 rotationally driven by a driving source (not illustrated) is uniformly charged to a predetermined potential by the charging roller 12. After the photosensitive drum 11 is charged, the laser scanner 101 performs exposure based on image information on a surface of the photosensitive drum, charge is removed from the exposed portion, and an electrostatic latent image is formed. Toner is supplied from the developing roller 16 to an electrostatic latent image on the photosensitive drum 11 and the electrostatic latent image is visualized as a toner image.

Meanwhile, in parallel with the toner image forming operation, the sheet S is conveyed by the feeding roller 103. Specifically, the feeding roller 103 rotates to feed the sheet S. Subsequently, the sheet S is conveyed between the photosensitive drum 11 and the transfer roller 104 in synchronization with a timing of forming the toner image on the photosensitive drum 11. As the sheet S passes between the photosensitive drum 11 and the transfer roller 104 that is a transferring part (transferring device), a bias applied to the transfer roller 104 causes the toner image to be transferred onto the sheet S as an unfixed image. Subsequently, the sheet S onto which the toner image has been transferred is conveyed to the fixing portion 105 that is a fixing part (fixing device). As the sheet S having been conveyed to the fixing portion 105 passes the fixing portion 105, the unfixed toner image is subjected to heat and pressure and fixed to the surface of the sheet S. In other words, the fixing portion 105 is configured to heat and press the sheet S. Subsequently, the sheet S is conveyed by the conveying roller 106, discharged to outside of the machine by the paper discharge roller 108, and stacked on the paper discharge tray 109.

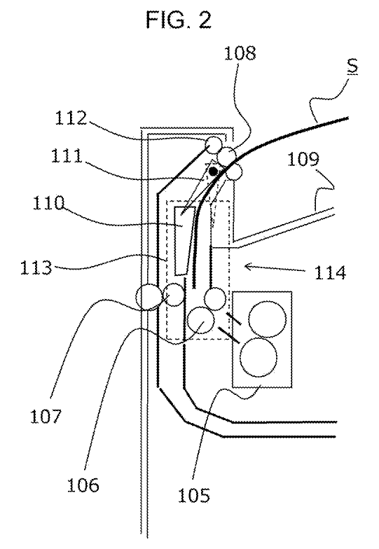

FIG. 2 is a sectional view for describing a configuration of a conveying path from the fixing portion 105 to the paper discharge roller 108 of the image forming apparatus 1 shown in FIG. 1. The conveying path of the sheet S is provided with a flapper 111 as a conveying guide that guides the sheet S on a downstream side of the fixing portion 105. The flapper 111 extends in a direction orthogonal to the conveying path and switches the conveying path (paper path) of the sheet S at a branching position between a paper discharging conveying path and a reverse conveying path.

During single-sided printing, the sheet S printed on one side is guided by a conveying guide 110 and the flapper 111 and subsequently discharged by the paper discharge roller 108 into the paper discharge tray 109.

During double-sided printing, the sheet S printed on one side is guided to the reverse conveying path by the flapper 111 having swung to a position indicated by a dotted line. The sheet S sandwiched by the paper discharge roller 108 and a reverse rotation roller 112 is reversed and subsequently conveyed to a duplex conveying path. Toner thermally fixed to the sheet S may adhere to the conveying guide 110 due to strong rubbing against the conveying guide 110. When the conveying guide 110 becomes warm by receiving heat of the sheet S due to continuous paper feed or the like, the toner is more likely to adhere.

In the case of single-sided printing, the conveying guide 110 guides a non-printed surface side of the sheet S and does not slide against the sheet S. However, in the case of double-sided printing, since both sides of the sheet S are printed, a printed surface slides against the conveying guide 110 when the sheet S is conveyed along a curved conveying path (such as the conveying guide 110 and the flapper 111 shown in FIG. 2) on a downstream side of the fixing portion 105. A conveying apparatus 114 includes the conveying roller 106, the conveying guide 110, and a main body frame 113 that supports the conveying roller 106 and the conveying guide 110, and conveys the sheet S. Note that the main body frame 113 may be configured to support other members.

The conveying guide 110 that slides against the sheet S on the downstream side of the fixing portion 105 is formed of a material to which toner is unlikely to adhere such as polyoxymethylene (POM), polyacetal, or other resins. Accordingly, an occurrence of a phenomenon where toner adheres to and solidifies on the conveying guide 110 (toner fixation) can be suppressed. Therefore, an occurrence of an image defect due to the toner adhering to the conveying guide 110 and an occurrence of a jam due to paper catching on fixed toner can be suppressed.

Since resins such as POM and polyacetal have a high rate of thermal expansion and thermally contract, dimensions fluctuate significantly due to thermal effects. In addition, components formed of such resins are prone to warping. Therefore, when forming components that are elongated in the rotational axis direction such as the conveying guide 110 and the flapper 111 of resins, a configuration that is less susceptible to thermal effects is preferably adopted. Hereinafter, various embodiments of the conveying guide 110 will be described. In the following embodiments, the reference sign of the conveying guide 110 will be changed for each embodiment.

### First Embodiment

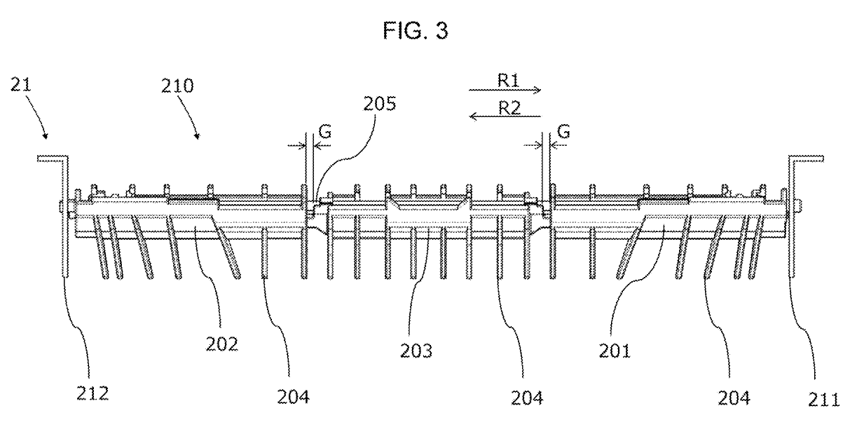

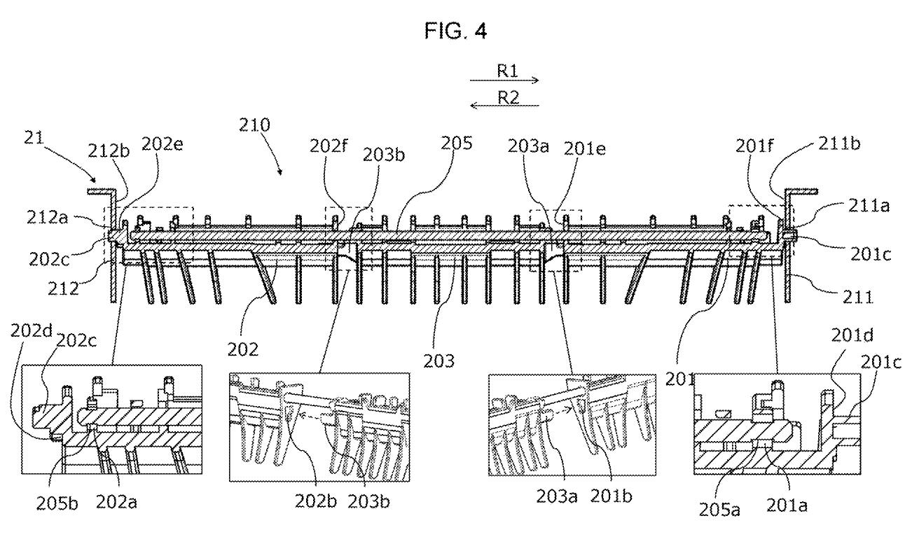

A conveying guide 210 according to a first embodiment will be described with reference to FIGS. 3 and 4. FIG. 3 is a front view of the conveying guide 210 according to the first embodiment as viewed from a direction orthogonal to the rotational axis direction. FIG. 4 is a sectional view of the conveying guide 210 according to the first embodiment along a cross section parallel to the rotational axis direction.

The conveying guide 210 includes three guiding members, namely, a first guiding member 201 arranged at one end in the rotational axis direction, a second guiding member 202 arranged at the other end in the rotational axis direction, and a third guiding member 203 arranged at center in the rotational axis direction. The three guiding members 201 to 203 are arranged side by side in the rotational axis direction and connected by a connecting member (connecting beam) 205 to be integrated as the conveying guide 210. However, the number of guiding members arranged between the first guiding member 201 and the second guiding member 202 is arbitrary. In other words, the conveying guide 210 need not include a member corresponding to the third guiding member 203 or may include two or more guiding members corresponding to the third guiding member 203.

Each of the guiding members 201 to 203 includes a plurality of ribs 204 for guiding the sheet S. Positions of the plurality of ribs 204 differ from each other in the rotational axis direction. The plurality of ribs 204 enable the sheet S of various sizes to be accommodated.

The first guiding member 201 and the second guiding member 202 are positioned at both ends of the conveying guide 210 in the rotational axis direction. The third guiding member 203 is positioned in a central portion of the conveying guide 210. The ribs 204 of the third guiding member 203 guide a central portion of the sheet S in the width direction. In the case of the sheet S with a small size in the width direction, the central portion of the sheet S may not be guided by the ribs 204 of the third guiding member 203.

A gap G is provided between two guiding members that are adjacent to each other in the rotational axis direction (between the first guiding member 201 and the third guiding member 203 and between the second guiding member 202 and the third guiding member 203). The gap G is set so as to be capable of absorbing dimensional changes in the guiding members 201 to 203 in the rotational axis direction when the guiding members 201 to 203 expand thermally due to heat from the fixing portion 105 or the printed sheet S.

A main body frame 21 includes a first frame 211 and a second frame 212. The first frame 211 and the second frame 212 are formed by metal and, more specifically, sheet metal. Alternatively, the first frame 211 and the second frame 212 may be formed of resin. In the following description, a direction parallel to the rotational axis direction and oriented from the second frame 212 toward the first frame 211 will be defined as a first direction R1 and a direction opposite to the first direction R1 will be defined as a second direction R2. The conveying roller 106 is rotatably supported by the main body frame 21. In the rotational axis direction, the first guiding member 201 is closer to the first frame 211 than to the second frame 212 and the second guiding member 202 is closer to the second frame 212 than to the first frame 211.

The first frame 211 includes a first engaging portion 211a and the second frame 212 includes a second engaging portion 212a. The conveying guide 210 is arranged sandwiched between the first frame 211 and the second frame 212 with respect to the rotational axis direction of the conveying roller 106 and rotatably supported by engaging with the first frame 211 and the second frame 212 at both end portions in the rotational axis direction. The conveying guide 210 includes a first engaged portion 201c that engages with the first engaging portion 211a of the first frame 211 and a second engaged portion 202c that engages with the second engaging portion 212a of the second frame 212. The first engaged portion 201c is provided in the first guiding member 201 and the second engaged portion 202c is provided in the second guiding member 202. The first engaged portion 201c engages with the first engaging portion 211a so as to be rotatable around an axis parallel to the rotational axis direction, and the second engaged portion 202c engages with the second engaging portion 212a so as to be rotatable around an axis parallel to the rotational axis direction.

The first frame 211 includes an end surface 211b being a first restricting portion that restricts relative movement of the first guiding member 201 with respect to the main body frame 21 in the first direction R1. The end surface 211b extends in a direction that intersects with the rotational axis direction. The end surface 211b contacts with an end surface 201d facing the first direction R1 of the first engaged portion 201c of the first guiding member 201 to restrict the first guiding member 201 from moving relative to the main body frame 21 in the first direction R1. The end surface 201d extends in a direction that intersects with the rotational axis direction. In other words, when the first guiding member 201 receives an external force in the first direction R1, the end surface 201d contacts with the end surface 211b, thereby restricting the movement of the first guiding member 201. The first guiding member 201 includes one end 201f and the other end 201e in the rotational axis direction, and the one end 201f is closer to the first frame 211 than the other end 201e. The end surface 211b of the first frame 211 that is the first restricting portion is closer to the one end 201f than to the other end 201e of the first guiding member 201 in the rotational axis direction.

The second frame 212 includes an end surface 212b being a second restricting portion that restricts relative movement of the second guiding member 202 with respect to the main body frame 21 in the second direction R2. The end surface 212b extends in a direction that intersects with the rotational axis direction. The end surface 212b contacts with an end surface 202d facing the second direction R2 of the second engaged portion 202c of the second guiding member 202 to restrict the second guiding member 202 from moving relative to the main body frame 21 in the second direction R2. The end surface 202d extends in a direction that intersects with the rotational axis direction. In other words, when the second guiding member 202 receives an external force in the second direction R2, the end surface 202d contacts with the end surface 212b, thereby restricting the movement of the second guiding member 202. The second guiding member 202 includes one end 202f and the other end 202e in the rotational axis direction, and the one end 202f is closer to the second frame 212 than the other end 202e is. The end surface 212b of the second frame 212 that is the second restricting portion is closer to the other end 202e than to the one end 202f of the second guiding member 202 in the rotational axis direction.

The conveying guide 210 is sandwiched between the first frame 211 and the second frame 212 in the rotational axis direction. The conveying guide 210 is positioned in the rotational axis direction based on a distance between the first frame 211 and the second frame 212 in the rotational axis direction.

The third guiding member 203 configured to guide the sheet S is positioned in the rotational axis direction by being sandwiched between the first guiding member 201 and the second guiding member 202 in the rotational axis direction.

The connecting member 205 is a metallic shaft member with a diameter of 3 mm. The connecting member 205 has a columnar shape and is inserted into a fitting hole which is provided in the guiding members 201 to 203 and which has an inner diameter that is approximately the same as an outer diameter of the columnar shape of the connecting member 205. Accordingly, the three guiding members 201 to 203 are linearly arranged along the rotational axis direction, restricted from moving in a direction orthogonal to the rotational axis direction, and strengths thereof are secured by the connecting member 205 that is a metallic shaft member.

The third guiding member 203 is engaged with the first guiding member 201 and the second guiding member 202. More specifically, one of the third guiding member 203 and the first guiding member 201 includes a hole and the other includes a projection that fits into the hole. In addition, one of the third guiding member 203 and the second guiding member 202 includes a hole and the other includes a projection that fits into the hole. In the present embodiment, the third guiding member 203 includes projected portions 203a and 203b that protrude in the rotational axis direction. The projected portion 203a fits into a hole 201b of the first guiding member 201 and the projected portion 203b fits into a hole 202b of the second guiding member 202. Accordingly, the guiding members 201 to 203 are positioned such that tips of the ribs 204 align linearly in the rotational axis direction. The projected portions 203a and 203b of the third guiding member 203 fit with clearance into the hole 201b of the first guiding member 201 and the hole 202b of the second guiding member 202, respectively. Therefore, the third guiding member 203 is movable in the rotational axis direction with respect to the first guiding member 201 and the second guiding member 202. Note that the first guiding member 201 may include a projected portion that corresponds to the projected portion 203a and the third guiding member 203 may include a hole that corresponds to the hole 201b. In addition, the second guiding member 202 may include a projected portion that corresponds to the projected portion 203b and the third guiding member 203 may include a hole that corresponds to the hole 202b.

The connecting member 205 includes a first groove portion 205a on one end side (right side in FIGS. 3 and 4) and a second groove portion 205b on the other end side (left side in FIGS. 3 and 4) in the rotational axis direction.

A first movement restricting portion 201a provided in the first guiding member 201 fits into the first groove portion 205a, and two end surfaces that oppose each other to form the first groove portion 205a contact with the first movement restricting portion 201a. In other words, the connecting member 205 contacts with the first guiding member 201. Accordingly, the connecting member 205 is restricted from moving relative to the first guiding member 201 in the first direction R1 and in the second direction R2. In other words, when the connecting member 205 receives an external force in the first direction R1 and when the connecting member 205 receives an external force in the second direction R2, one of the two end surfaces that form the first groove portion 205a contacts with the first movement restricting portion 201a. In addition, the movement of the connecting member 205 with respect to the first guiding member 201 is restricted. Each of the two end surfaces that oppose each other to form the first groove portion 205a extends in a direction that intersects with the rotational axis direction. The first movement restricting portion 201a extends in a direction that intersects with the rotational axis direction.

A second movement restricting portion 202a provided in the second guiding member 202 fits into the second groove portion 205b, and two end surfaces that oppose each other to form the second groove portion 205b contact with the second movement restricting portion 202a. In other words, the connecting member 205 contacts with the second guiding member 202. Accordingly, the connecting member 205 is restricted from moving relative to the second guiding member 202 in the first direction R1 and in the second direction R2. In other words, when the connecting member 205 receives an external force in the first direction R1 and when the connecting member 205 receives an external force in the second direction R2, one of the two end surfaces that form the second groove portion 205b contacts with the second movement restricting portion 202a. In addition, the movement of the connecting member 205 with respect to the second guiding member 202 is restricted. Each of the two end surfaces that oppose each other to form the second groove portion 205b extends in a direction that intersects with the rotational axis direction. The second movement restricting portion 202a extends in a direction that intersects with the rotational axis direction.

Due to the configuration described above, the first guiding member 201 and the second guiding member 202 are positioned with respect to the connecting member 205 in the rotational axis direction. In other words, the first guiding member 201 and the second guiding member 202 are restricted from moving relative to the connecting member 205 in the first direction R1 and in the second direction R2.

As described above, the connecting member 205 is restricted from moving relative to the first guiding member 201 and the second guiding member 202 in the first direction R1 and in the second direction R2. In addition, the first guiding member 201 is restricted from moving in the first direction R1 with respect to the first frame 211, and the second guiding member 202 is restricted from moving in the second direction R2 with respect to the second frame 212. Therefore, the connecting member 205 is restricted from moving relative to the main body frame 21 in the first direction R1 and in the second direction R2.

When the first guiding member 201 receives an external force in the second direction R2, the first movement restricting portion 201a of the first guiding member 201 contacts with one of the two end surfaces that form the first groove portion 205a and an external force in the second direction R2 acts on the connecting member 205. In addition, one of the two end surfaces that form the second groove portion 205b of the connecting member 205 contacts with the second movement restricting portion 202a and an external force in the second direction R2 acts on the second guiding member 202. In addition, the end surface 202d of the second guiding member 202 contacts with the end surface 212b, thereby restricting the movement of the second guiding member 202. As a result, the first guiding member 201 is restricted from moving with respect to the main body frame 21 in the second direction R2.

When the second guiding member 202 receives an external force in the first direction R1, the second movement restricting portion 202a of the second guiding member 202 contacts with one of the two end surfaces that form the second groove portion 205b and an external force in the first direction R1 acts on the connecting member 205. In addition, one of the two end surfaces that form the first groove portion 205a of the connecting member 205 contacts with the first movement restricting portion 201a and an external force in the first direction R1 acts on the first guiding member 201. In addition, the end surface 201d of the first guiding member 201 contacts with the end surface 211b, thereby restricting the movement of the first guiding member 201. As a result, the second guiding member 202 is restricted from moving with respect to the main body frame 21 in the first direction R1.

The first movement restricting portion 201a of the first guiding member 201 is provided in a vicinity of the first frame 211 in the rotational axis direction, and the second movement restricting portion 202a of the second guiding member 202 is provided in a vicinity of the second frame 212 in the rotational axis direction.

The connecting member 205 is made of metal, and the guiding members 201 to 203 are made of resin. In other words, a thermal expansion coefficient of the connecting member 205 is less than a thermal expansion coefficient of the guiding members 201 to 203. Therefore, the connecting member 205 that extends to vicinities of both ends of the conveying guide 210 in the rotational axis direction is less susceptible to thermal effects. Therefore, even if the guiding members 201 to 203 are formed of a resin susceptible to thermal effects, the length of the conveying guide 210 in the rotational axis direction can be prevented from varying due to thermal expansion and contraction. Accordingly, there is no longer a need to set an excessive clearance or an excessive amount of engagement in the rotational axis direction to account for dimensional changes in the rotational axis direction caused by heat. Therefore, even in a configuration in which the conveying guide 210 is positioned in the rotational axis direction by sandwiching the conveying guide 210 between the first frame 211 and the second frame 212, the clearance in the rotational axis direction can be set to a small value.

In addition, even if the guiding members 201 to 203 are formed of a material that is susceptible to thermal effects, the positional variation of the ribs 204 of the first guiding member 201 and the second guiding member 202 can be minimized. Therefore, even when configured such that the ribs on the upstream side and the ribs on the downstream side are in a comb-tooth positional relationship in the conveying direction, interference between the ribs can be suppressed without having to secure a large clearance between the ribs. Therefore, restrictions on the arrangement of the ribs can be suppressed.

While an example in which the first frame 211 and the second frame 212 are separate components has been described in the first embodiment, the first frame 211 and the second frame 212 are not limited to the example. The first frame 211 and the second frame 212 may be integrally constructed. This also applies to the following embodiments.

In addition, while a configuration in which the third guiding member 203 is positioned by being sandwiched between the first guiding member 201 and the second guiding member 202 in the rotational axis direction has been described in the first embodiment, the positioning of the third guiding member 203 is not limited thereto. The third guiding member 203 may be configured to be positioned with respect to the connecting member 205 in a similar manner to the first guiding member 201 and the second guiding member 202. In other words, a configuration may be adopted in which the third guiding member 203 and the connecting member 205 contact with each other to restrict the third guiding member 203 from moving relative to the connecting member 205 in the first direction R1 and in the second direction R2.

### Second Embodiment

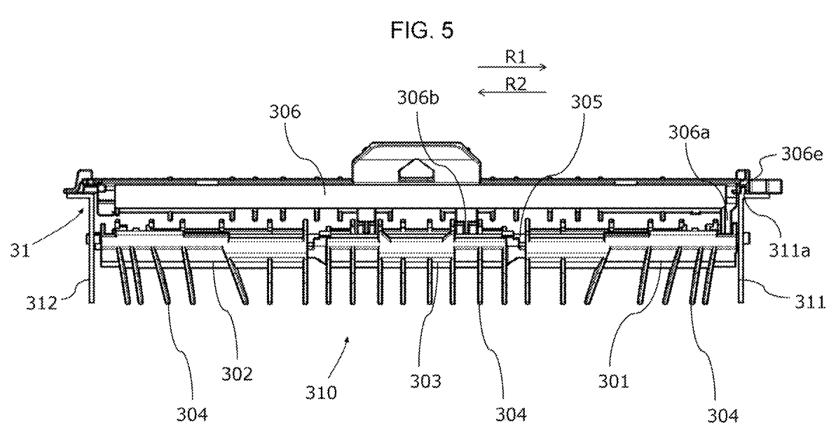

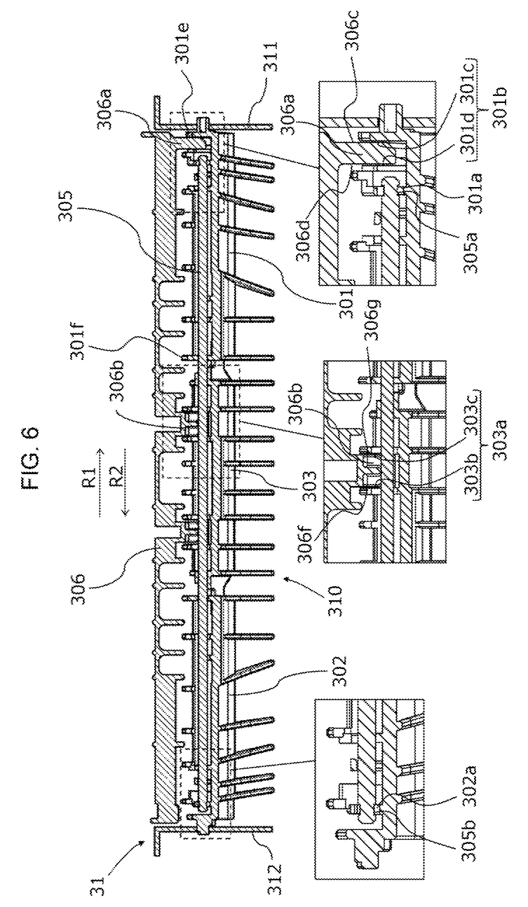

A conveying guide 310 according to a second embodiment will be described with reference to FIGS. 5 and 6. FIG. 5 is a front view of the conveying guide 310 according to the second embodiment as viewed from a direction orthogonal to the rotational axis direction. FIG. 6 is a sectional view of the conveying guide 310 according to the second embodiment along a cross section parallel to the rotational axis direction. It should be noted that descriptions of portions that overlap with the description of the first embodiment will not be repeated and different portions will be mainly described.

Similarly to the first embodiment, the conveying guide 310 includes a first guiding member 301 that engages with a first frame 311, a second guiding member 302 that engages with a second frame 312, and a third guiding member 303 positioned therebetween in the rotational axis direction. A connecting member 305 is inserted through the guiding members 301 to 303 and restricts movement of the guiding members 301 to 303 in a direction orthogonal to the rotational axis direction.

A main body frame 31 includes the first frame 311 and the second frame 312. In the rotational axis direction, the first guiding member 301 is closer to the first frame 311 than to the second frame 312 and the second guiding member 302 is closer to the second frame 312 than to the first frame 311. The first frame 311 and the second frame 312 are formed of metal and, more specifically, sheet metal. Alternatively, the first frame 311 and the second frame 312 may be formed of resin.

A stay member 306 is fixed so as to bridge between the first frame 311 and the second frame 312. The stay member 306 includes a groove-like restricted portion 306e and the first frame 311 includes a projection-like stay restricting portion 311a. An end surface of the restricted portion 306e facing the first direction R1 and an end surface of the stay restricting portion 311a facing the second direction R2 contact with each other, and an end surface of the restricted portion 306e facing the second direction R2 and an end surface of the stay restricting portion 311a facing the first direction R1 contact with each other. Accordingly, the stay member 306 is restricted from moving relative to the first frame 311 and the main body frame 31 in the first direction R1 and in the second direction R2. The stay member 306 includes a first guide restricting portion 306a provided on a side of the first frame 311 and a third guide restricting portion 306b provided in a vicinity of a central portion in the rotational axis direction.

The connecting member 305 includes a first groove portion 305a on one end side (right side in FIGS. 5 and 6) and a second groove portion 305b on the other end side (left side in FIGS. 5 and 6) in the rotational axis direction.

A first movement restricting portion 301a provided in the first guiding member 301 fits into the first groove portion 305a, and two end surfaces that oppose each other to form the first groove portion 305a contact with the first movement restricting portion 301a. In other words, the connecting member 305 contacts with the first guiding member 301. Accordingly, the connecting member 305 is restricted from moving relative to the first guiding member 301 in the first direction R1 and in the second direction R2. In other words, when the connecting member 305 receives an external force in the first direction R1 and when the connecting member 305 receives an external force in the second direction R2, one of the two end surfaces that form the first groove portion 305a contacts with the first movement restricting portion 301a. In addition, the movement of the connecting member 305 with respect to the first guiding member 301 is restricted. Each of the two surfaces that oppose each other to form the first groove portion 305a extends in a direction that intersects with the rotational axis direction. The first movement restricting portion 301a extends in a direction that intersects with the rotational axis direction.

A second movement restricting portion 302a provided in the second guiding member 302 fits into the second groove portion 305b, and two surfaces that oppose each other to form the second groove portion 305b contact with the second movement restricting portion 302a. In other words, the connecting member 305 contacts with the second guiding member 302. Accordingly, the connecting member 305 is restricted from moving relative to the second guiding member 302 in the first direction R1 and in the second direction R2. In other words, when the connecting member 305 receives an external force in the first direction R1 and when the connecting member 305 receives an external force in the second direction R2, one of the two end surfaces that form the second groove portion 305b contacts with the second movement restricting portion 302a. In addition, the movement of the connecting member 305 with respect to the second guiding member 302 is restricted. Each of the two surfaces that oppose each other to form the second groove portion 305b extends in a direction that intersects with the rotational axis direction. The second movement restricting portion 302a extends in a direction that intersects with the rotational axis direction.

Due to the configuration described above, the first guiding member 301 and the second guiding member 302 are positioned with respect to the connecting member 305 in the rotational axis direction. In other words, the first guiding member 301 and the second guiding member 302 are restricted from moving relative to the connecting member 305 in the first direction R1 and in the second direction R2.

Since the first movement restricting portion 301a and the second movement restricting portion 302a are provided at positions of ribs 304 in the vicinity of both ends in the rotational axis direction, the positions of the ribs 304 in the vicinity of both ends in the rotational axis direction minimize thermal effects.

The first guiding member 301 includes a first guide restricted portion 301b, the first guide restricting portion 306a of the stay member 306 fits into the first guide restricted portion 301b, and the first guide restricting portion 306a contacts with the first guide restricted portion 301b. In other words, the first guiding member 301 and the stay member 306 contact with each other. Accordingly, the first guiding member 301 is restricted from moving relative to the stay member 306 and the first frame 311 in the first direction R1 and in the second direction R2. Accordingly, the first guiding member 301 is positioned with respect to the first frame 311 in the rotational axis direction.

Specifically, the first guide restricting portion 306a includes an end surface 306c facing the first direction R1 and an end surface 306d facing the second direction R2. The end surface 306c and the end surface 306d extend in a direction that intersects with the rotational axis direction. The first guide restricted portion 301b includes an end surface 301c facing the second direction R2 and an end surface 301d facing the first direction R1. The end surface 301c and the end surface 301d extend in a direction that intersects with the rotational axis direction. The end surface 306c of the first guide restricting portion 306a and the end surface 301c of the first guide restricted portion 301b contact with each other to restrict the first guiding member 301 from moving relative to the stay member 306 and the main body frame 31 in the second direction R2. In other words, when the first guiding member 301 receives an external force in the second direction R2, the end surface 301c contacts with the end surface 306c, thereby restricting the movement of the first guiding member 301. The end surface 306d of the first guide restricting portion 306a and the end surface 301d of the first guide restricted portion 301b contact with each other to restrict the first guiding member 301 from moving relative to the stay member 306 and the main body frame 31 in the first direction R1. In other words, when the first guiding member 301 receives an external force in the first direction R1, the end surface 301d contacts with the end surface 306d, thereby restricting the movement of the first guiding member 301. In other words, the first guide restricting portion 306a is a first restricting portion that restricts relative movement of the first guiding member 301 with respect to the main body frame 31 in the first direction R1 and the second direction R2.

The third guiding member 303 includes a third guide restricted portion 303a, the third guide restricting portion 306b of the stay member 306 fits into the third guide restricted portion 303a, and the third guide restricting portion 306b contacts with the third guide restricted portion 303a. In other words, the third guiding member 303 and the stay member 306 contact with each other. Accordingly, the third guiding member 303 is restricted from moving relative to the stay member 306 and the first frame 311 in the first direction R1 and in the second direction R2. Accordingly, the third guiding member 303 is positioned with respect to the first frame 311 in the rotational axis direction.

Specifically, the third guide restricting portion 306b includes an end surface 306g facing the first direction R1 and an end surface 306f facing the second direction R2. The end surface 306g and the end surface 306f extend in a direction that intersects with the rotational axis direction. Specifically, the third guide restricted portion 303a includes an end surface 303b facing the first direction R1 and an end surface 303c facing the second direction R2. The end surface 303b and the end surface 303c extend in a direction that intersects with the rotational axis direction. The end surface 306g of the third guide restricting portion 306b and the end surface 303c of the third guide restricted portion 303a contact with each other to restrict the third guiding member 303 from moving relative to the stay member 306 and the main body frame 31 in the second direction R2. In other words, when the third guiding member 303 receives an external force in the second direction R2, the end surface 303c contacts with the end surface 306g, thereby restricting the movement of the third guiding member 303. The end surface 306f of the third guide restricting portion 306b and the end surface 303b of the third guide restricted portion 303a contact with each other to restrict the third guiding member 303 from moving relative to the stay member 306 and the main body frame 31 in the first direction R1. In other words, when the third guiding member 303 receives an external force in the first direction R1, the end surface 303b contacts with the end surface 306f, thereby restricting the movement of the third guiding member 303. In other words, the third guide restricting portion 306b is a third restricting portion that restricts relative movement of the third guiding member 303 with respect to the main body frame 31 in the first direction R1 and the second direction R2.

As described above, the connecting member 305 is restricted from moving relative to the first guiding member 301 in the first direction R1 and in the second direction R2. In addition, as described above, the first guiding member 301 is restricted from moving relative to the main body frame 31 in the first direction R1 and in the second direction R2. Therefore, the connecting member 305 is restricted from moving relative to the main body frame 31 in the first direction R1 and in the second direction R2.

When the second guiding member 302 receives an external force in the first direction R1, the second movement restricting portion 302a of the second guiding member 302 contacts with one of the two end surfaces that form the second groove portion 305b and an external force in the first direction R1 acts on the connecting member 305. In addition, one of the two end surfaces that form the first groove portion 305a of the connecting member 305 contacts with the first movement restricting portion 301a and an external force in the first direction R1 acts on the first guiding member 301. In addition, the end surface 301d of the first guiding member 301 contacts with the end surface 306d, thereby restricting the movement of the first guiding member 301. As a result, the second guiding member 302 is restricted from moving with respect to the main body frame 31 in the first direction R1.

When the second guiding member 302 receives an external force in the second direction R2, the second movement restricting portion 302a of the second guiding member 302 contacts with the other of the two end surfaces that form the second groove portion 305b and an external force in the second direction R2 acts on the connecting member 305. In addition, one of the two end surfaces that form the first groove portion 305a of the connecting member 305 contacts with the first movement restricting portion 301a and an external force in the second direction R2 acts on the first guiding member 301. In addition, the end surface 301c of the first guiding member 301 contacts with the end surface 306c, thereby restricting the movement of the first guiding member 301. As a result, the second guiding member 302 is restricted from moving with respect to the main body frame 31 in the second direction R2.

As described above, the second guiding member 302 is restricted from moving with respect to the main body frame 31 in the first direction R1 and in the second direction R2. In other words, when the second guiding member 302 receives an external force in the first direction R1 and when the second guiding member 302 receives an external force in the second direction R2, the second guiding member 302 contacts with the connecting member 305. In addition, the connecting member 305 contacts with the first guiding member 301 and the first guiding member 301 contacts with the first guide restricting portion 306a to restrict the movement of the second guiding member 302.

Both the first guide restricting portion 306a and the first movement restricting portion 301a are provided in a vicinity of the first frame 311 in the rotational axis direction. In other words, the first guiding member 301 includes one end 301e and the other end 301f, and the one end 301e is closer to the first frame 311 than the other end 301f is. In addition, the first guide restricting portion 306a and the first movement restricting portion 301a are closer to the one end 301e than to the other end 301f in the rotational axis direction.

This offers the following two advantages. First, since a distance between the first guide restricting portion 306a and the first movement restricting portion 301a in the rotational axis direction is short, a variation in the position of the connecting member 305 can be suppressed when the first guiding member 301 expands or contracts due to heat. Second, since the first guide restricting portion 306a is located in an end portion in the rotational axis direction, the stay member 306 is unlikely to receive heat released from the recording material. In addition, since the distance between the first guide restricting portion 306a and the first movement restricting portion 301a in the rotational axis direction is short, a variation in the position of the first guide restricting portion 306a due to heat can be suppressed.

The connecting member 305 that is less susceptible to thermal effects extends to the vicinity of both ends of the conveying guide 310 in the rotational axis direction. Therefore, even if the guiding members 301 to 303 are formed of a resin susceptible to thermal effects, an overall length of the conveying guide 310 in the rotational axis direction can be prevented from varying due to thermal expansion and contraction. In addition, since the first guide restricting portion 306a is in the vicinity of the first frame 311, the positioning of the conveying guide 310 with respect to the first frame 311 and the second frame 312 is less likely to be affected by the expansion and contraction of the stay member 306 due to heat. Furthermore, since the first guide restricting portion 306a and the first guide restricted portion 301b can be positioned solely by fitting clearance, positional variations of the ribs 304 on the first guiding member 301 or the second guiding member 302 can be suppressed.

While a configuration in which the third guiding member 303 is positioned by the third guide restricting portion 306b has been described in the second embodiment, the positioning of the third guiding member 303 is not limited thereto. For example, the third guiding member 303 may be positioned in the rotational axis direction by providing a groove portion in the connecting member 305 and providing a movement restricting portion that fits with the groove portion in a similar manner to the first guiding member 301 and the second guiding member 302. In addition, the third guiding member 303 may be configured to be positioned in the rotational axis direction by being sandwiched between the first guiding member 301 and the second guiding member 302 in a similar manner to the first embodiment.

### Modification of Second Embodiment

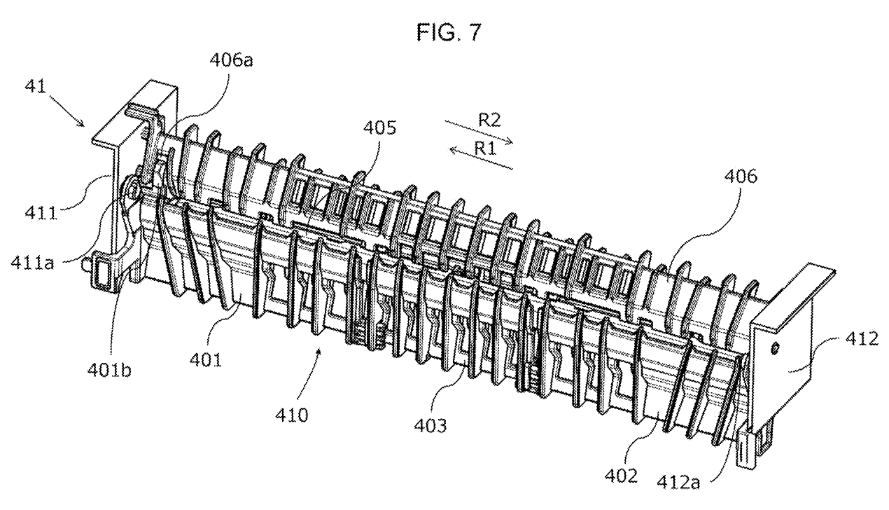

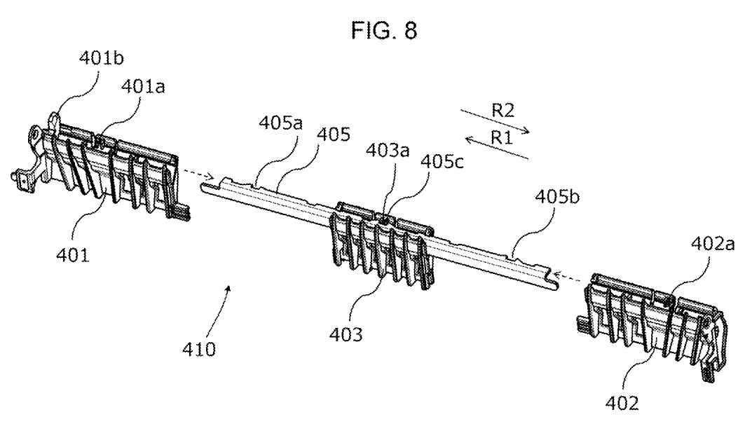

A conveying guide 410 according to a modification of the second embodiment will be described with reference to FIGS. 7 and 8. FIG. 7 is a perspective view of the conveying guide 410 according to the modification of the second embodiment. FIG. 8 is an exploded perspective view of the conveying guide 410 according to the modification of the second embodiment. A difference from the second embodiment is that a connecting member 405 is formed by a sheet metal.

The conveying guide 410 includes three guiding members (first guiding member 401, second guiding member 402, and third guiding member 403) in a similar manner to the second embodiment. The connecting member 405 is formed by a 1.6 mm-thick sheet metal with an L-shaped cross section perpendicular to the rotational axis direction. The connecting member 405 is inserted into a fitting hole which is provided in the guiding members 401 to 403 and which extends in the rotational axis direction, and restricts movement of the guiding members 401 to 403 in a direction orthogonal to the rotational axis direction.

A main body frame 41 includes a first frame 411 and a second frame 412. The first guiding member 401 of the conveying guide 410 engages with a first engaging portion 411a of the first frame 411 and the second guiding member 402 of the conveying guide 410 engages with a second engaging portion 412a of the second frame 412. A stay member 406 is fixed so as to bridge between the first frame 411 and the second frame 412. The stay member 406 is positioned in the rotational axis direction with respect to the first frame 411 by a structure similar to that of the stay member 306 according to the second embodiment.

A first guide restricting portion 401b provided in the first guiding member 401 fits into a first guide restricted portion 406a of the stay member 406, and the first guide restricting portion 401b and the first guide restricted portion 406a contact with each other. In other words, the first guiding member 401 and the stay member 406 contact with each other. Accordingly, the first guiding member 401 is restricted from moving relative to the stay member 406, the first frame 411, and the main body frame 41 in the first direction R1 and in the second direction R2. Accordingly, the first guiding member 401 is positioned with respect to the main body frame 41 in the rotational axis direction. The first guide restricting portion 401b is a first restricting portion that restricts relative movement of the first guiding member 401 with respect to the main body frame 41 in the first direction R1 and the second direction R2.

FIG. 8 shows a state where the third guiding member 403 is incorporated into the connecting member 405. The guiding members 401 to 403 are configured to be incorporated by sliding in the rotational axis direction with respect to the connecting member 405. The connecting member 405 is provided with three depressed portions 405a, 405b, and 405c.

A first movement restricting portion 401a provided in the first guiding member 401 fits into the depressed portion 405a and the depressed portion 405a contacts with the first movement restricting portion 401a. In other words, the connecting member 405 contacts with the first guiding member 401. Accordingly, the connecting member 405 is restricted from moving relative to the first guiding member 401 in the first direction R1 and in the second direction R2.

A second movement restricting portion 402a provided in the second guiding member 402 fits into the depressed portion 405b and the depressed portion 405b contacts with the second movement restricting portion 402a. In other words, the connecting member 405 contacts with the second guiding member 402. Accordingly, the connecting member 405 is restricted from moving relative to the second guiding member 402 in the first direction R1 and in the second direction R2.

A third movement restricting portion 403a provided in the third guiding member 403 fits into the depressed portion 405c and the depressed portion 405c contacts with the third movement restricting portion 403a. In other words, the connecting member 405 contacts with the third guiding member 403. Accordingly, the connecting member 405 is restricted from moving relative to the third guiding member 403 in the first direction R1 and in the second direction R2.

Due to each of the movement restricting portions 401a to 403a being fitted into each of the depressed portions 405a to 405c as described above, the guiding members 401 to 403 and the connecting member 405 are positioned in the rotational axis direction. In other words, the guiding members 401 to 403 are restricted from moving relative to the connecting member 405 in the first direction R1 and in the second direction R2.

As described above, the first guiding member 401 is restricted from moving relative to the main body frame 41 in the first direction R1 and in the second direction R2. In addition, the connecting member 405 is restricted from moving relative to the first guiding member 401 in the first direction R1 and in the second direction R2. Therefore, the connecting member 405 is restricted from moving relative to the main body frame 41 in the first direction R1 and in the second direction R2.

Even in the present modification, the second guiding member 402 is restricted from moving with respect to the main body frame 41 in the first direction R1 and in the second direction R2. In other words, when the second guiding member 402 receives an external force in the first direction R1 and when the second guiding member 402 receives an external force in the second direction R2, the second guiding member 402 contacts with the connecting member 405. In addition, the connecting member 405 contacts with the first guiding member 401 and the first guiding member 401 contacts with the first guide restricted portion 406a to restrict the movement of the second guiding member 402.

In the second embodiment, a configuration has been described in which the third guiding member 303 is positioned in the rotational axis direction due to contact between the third guide restricting portion 306b of the stay member 306 and the third guide restricted portion 303a of the third guiding member 303. On the other hand, in the modification of the second embodiment, the third guiding member 403 is positioned in the rotational axis direction due to contact between the depressed portion 405c of the connecting member 405 and the third movement restricting portion 403a of the third guiding member 403. Note that the configuration for positioning the third guiding member in the rotational axis direction is not limited to these configurations and a configuration may be adopted in which the third guiding member is positioned by being sandwiched between the first guiding member and the second guiding member in a similar manner to the first embodiment.

The connecting member may be a metallic shaft member with a circular cross section (cylindrical or columnar) as in the first and second embodiments or a shaft member made of a sheet metal with a non-circular cross section (for example, an L-shape) as in the modification of the second embodiment. In addition, the material of the connecting member may be a non-metallic material (for example, plastic) as long as the thermal expansion coefficient of the material is less than the thermal expansion coefficient of the material of the guiding members (resin).

### Third Embodiment

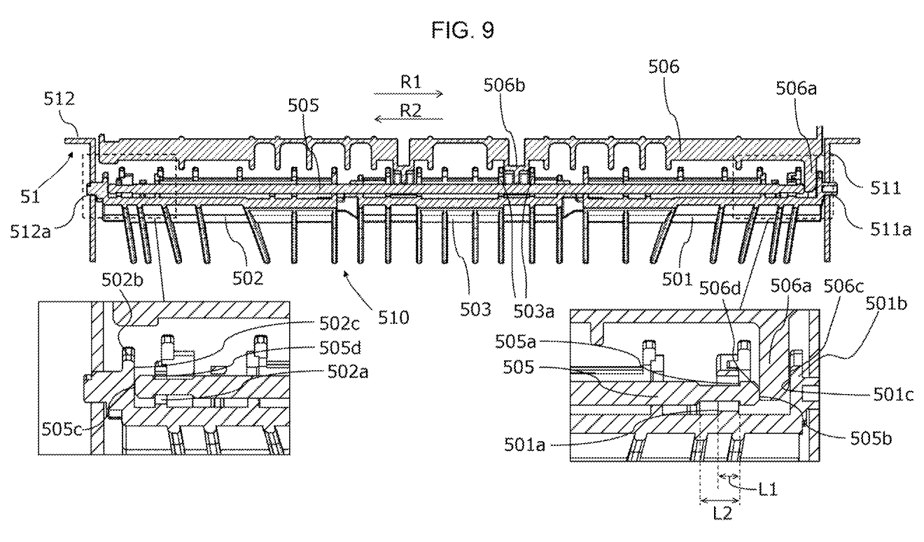

A conveying guide 510 according to a third embodiment will be described with reference to FIG. 9. FIG. 9 is a sectional view of the conveying guide 510 according to the third embodiment along a cross section parallel to the rotational axis direction. It should be noted that descriptions of portions that overlap with the description of the embodiments described above will not be repeated and different portions will be mainly described. Since a main body frame 51, a first frame 511, a second frame 512, and a stay member 506 are similar to those according to the second embodiment, descriptions will not be repeated. The conveying guide 510 includes a first guiding member 501, a second guiding member 502, and a third guiding member 503.

The first guiding member 501 includes a first movement restricting portion 501a. The first movement restricting portion 501a extends in a direction that intersects with the rotational axis direction. A connecting member 505 includes a stepped portion 505a. The stepped portion 505a extends in a direction that intersects with the rotational axis direction. The first movement restricting portion 501a and the stepped portion 505a contact with each other in a state where the conveying guide 510 is incorporated between the first frame 511 and the second frame 512 to restrict the first guiding member 501 from moving relative to the connecting member 505 in the first direction R1. In other words, the first guiding member 501 contacts with the connecting member 505 to restrict the first guiding member 501 from moving relative to the connecting member 505 in the first direction R1.

The first guiding member 501 includes a first guide restricted portion 501b and the first guide restricted portion 501b includes an end surface 501c facing the second direction R2. The end surface 501c extends in a direction that intersects with the rotational axis direction. The stay member 506 includes a guide restricting portion 506a and the guide restricting portion 506a includes an end surface 506c facing the first direction R1. The end surface 506c extends in a direction that intersects with the rotational axis direction. The end surface 506c and the end surface 501c contact with each other in a state where the conveying guide 510 is incorporated between the first frame 511 and the second frame 512 to restrict the first guiding member 501 from moving relative to the stay member 506 in the second direction R2. In other words, the guide restricting portion 506a is a first restricting portion that restricts relative movement of the first guiding member 501 with respect to the stay member 506 and the main body frame 51 in the second direction R2 by contacting with the first guiding member 501.

An end portion of the connecting member 505 closer to the first frame 511 includes an end surface 505b facing the first direction R1. The end surface 505b extends in a direction that intersects with the rotational axis direction. The guide restricting portion 506a includes an end surface 506d facing the second direction R2. The end surface 506d extends in a direction that intersects with the rotational axis direction. The end surface 505b and the end surface 506d contact with each other in a state where the conveying guide 510 is incorporated between the first frame 511 and the second frame 512 to restrict the connecting member 505 from moving relative to the stay member 506 in the first direction R1. In other words, the guide restricting portion 506a is a first restricting portion that restricts relative movement of the connecting member 505 with respect to the stay member 506 and the main body frame 51 in the first direction R1 by contacting with the connecting member 505.

The second guiding member 502 includes a second movement restricting portion 502a. The second movement restricting portion 502a extends in a direction that intersects with the rotational axis direction. The connecting member 505 includes a stepped portion 505d. The stepped portion 505d extends in a direction that intersects with the rotational axis direction. The second movement restricting portion 502a and the stepped portion 505d contact with each other in a state where the conveying guide 510 is incorporated between the first frame 511 and the second frame 512 to restrict the second guiding member 502 from moving relative to the connecting member 505 in the second direction R2.

The second guiding member 502 includes a second guide restricted portion 502b and the second guide restricted portion 502b includes an end surface 502c facing the first direction. The end surface 502c extends in a direction that intersects with the rotational axis direction. An end portion of the connecting member 505 closer to the second frame 512 includes an end surface 505c facing the second direction R2. The end surface 505c extends in a direction that intersects with the rotational axis direction. The end surface 502c and the end surface 505c contact with each other in a state where the conveying guide 510 is incorporated between the first frame 511 and the second frame 512 to restrict the second guiding member 502 from moving relative to the connecting member 505 in the first direction R1.

In other words, the second guiding member 502 contacts with the connecting member 505 such that an end portion of the connecting member 505 closer to the second frame 512 than the stepped portion 505d is sandwiched by the second movement restricting portion 502a of the second guiding member 502 and the second guide restricted portion 502b. Accordingly, the second guiding member 502 is restricted from moving relative to the connecting member 505 in the first direction R1 and in the second direction R2.

The stay member 506 includes a third guide restricting portion 506b provided in a vicinity of a central portion in the rotational axis direction. The third guiding member 503 includes a third guide restricted portion 503a. The third guide restricting portion 506b fits into the third guide restricted portion 503a, and the third guide restricting portion 506b contacts with the third guide restricted portion 503a. In other words, the third guiding member 503 and the stay member 506 contact with each other. Accordingly, the third guiding member 503 is restricted from moving relative to the stay member 506 and the first frame 511 in the first direction R1 and in the second direction R2. Accordingly, the third guiding member 503 is positioned with respect to the first frame 511 and the main body frame 51 in the rotational axis direction.

As described above, the connecting member 505 is restricted from moving relative to the main body frame 51 in the first direction R1. In addition, the first guiding member 501 is restricted from moving relative to the connecting member 505 in the first direction R1. In other words, the connecting member 505 is restricted from moving relative to the first guiding member 501 in the second direction R2. In addition, the first guiding member 501 is restricted from moving relative to the main body frame 51 in the second direction R2. Therefore, the connecting member 505 is restricted from moving relative to the main body frame 51 in the first direction R1 and in the second direction R2.

When the first guiding member 501 receives an external force in the first direction R1, the first movement restricting portion 501a of the first guiding member 501 contacts with the stepped portion 505a and an external force in the first direction R1 acts on the connecting member 505. In addition, the end surface 505b of the connecting member 505 contacts with the end surface 506d, thereby restricting the movement of the connecting member 505. As a result, the first guiding member 501 is restricted from moving with respect to the main body frame 51 in the first direction R1. In this manner, when the first guiding member 501 receives an external force in the first direction R1, the first guiding member 501 contacts with the connecting member 505. As a result, the connecting member 505 contacts with the guide restricting portion 506a to restrict the first guiding member 501 from moving relative to the main body frame 51.

When the first guiding member 501 receives an external force in the second direction R2, the end surface 501c of the first guiding member 501 contacts with the end surface 506c, thereby restricting the movement of the first guiding member 501. As a result, the first guiding member 501 is restricted from moving with respect to the main body frame 51 in the second direction R2. In this manner, the first guiding member 501 contacts with the guide restricting portion 506a when the first guiding member 501 receives an external force in the second direction R2 to restrict the first guiding member 501 from moving relative to the main body frame 51.

When the second guiding member 502 receives an external force in the first direction R1, the end surface 502c of the second guiding member 502 contacts with the end surface 505c of the connecting member 505 and an external force in the first direction R1 acts on the connecting member 505. In addition, the end surface 505b of the connecting member 505 contacts with the end surface 506d, thereby restricting the movement of the connecting member 505. As a result, the second guiding member 502 is restricted from moving with respect to the main body frame 51 in the first direction R1. In this manner, when the second guiding member 502 receives an external force in the first direction R1, the second guiding member 502 contacts with the connecting member 505. In addition, the connecting member 505 contacts with the guide restricting portion 506a to restrict the second guiding member 502 from moving relative to the main body frame 51.

When the second guiding member 502 receives an external force in the second direction R2, the second movement restricting portion 502a of the second guiding member 502 contacts with the stepped portion 505d of the connecting member 505 and an external force in the second direction R2 acts on the connecting member 505. In addition, the stepped portion 505a of the connecting member 505 contacts with the first movement restricting portion 501a of the first guiding member 501 and an external force in the second direction R2 acts on the first guiding member 501. In addition, the end surface 501c of the first guiding member 501 contacts with the end surface 506c, thereby restricting the movement of the first guiding member 501. In this manner, when the second guiding member 502 receives an external force in the second direction R2, the second guiding member 502 contacts with the connecting member 505. In addition, the connecting member 505 contacts with the first guiding member 501 and the first guiding member 501 contacts with the guide restricting portion 506a to restrict the second guiding member 502 from moving relative to the main body frame 51.

The stay member 506 is not present when the conveying guide 510 is not incorporated between the first frame 511 and the second frame 512. Therefore, a restriction on the movement of the first guiding member 501 in the second direction R2 due to contact between the guide restricting portion 506a and the first guiding member 501 is eliminated. In addition, a width L1 of the first movement restricting portion 501a in the rotational axis direction is less than a width L2 of the stepped portion 505a in the rotational axis direction. Therefore, the first guiding member 501 and the third guiding member 503 become movable with respect to the connecting member 505 in the rotational axis direction and the conveying guide 510 can contract in the rotational axis direction.

Accordingly, assemblability of the conveying guide 510 improves in a configuration in which the first frame 511 and the second frame 512 integrally form the main body frame 51 and an inter-frame distance between the first frame 511 and the second frame 512 in the rotational axis direction is fixed.

When incorporating a conveying guide incapable of contracting in the rotational axis direction between frames with a fixed inter-frame distance, the conveying guide must be incorporated by flexing it like a bow in the rotational axis direction. However, it is difficult to flex the conveying guide 510 of which rigidity has been enhanced by the metallic connecting member 505 as is the case of the conveying guide 510 according to the third embodiment.

Since the conveying guide 510 according to the third embodiment is capable of expanding and contracting in the rotational axis direction when the stay member 506 is absent, the conveying guide 510 need not be flexed even when incorporating the conveying guide 510 into the main body frame 51 with a fixed inter-frame distance. In other words, first, the conveying guide 510 is set between the first frame 511 and the second frame 512 in a state where the conveying guide 510 is contracted in the rotational axis direction. Subsequently, the conveying guide 510 is expanded in the rotational axis direction and incorporated into the main body frame 51 such that the first guiding member 501 and the second guiding member 502 engage with an engaging portion 511a of the first frame 511 and an engaging portion 512a of the second frame 512, respectively. By incorporating the stay member 506 in this state, positions of the guiding members 501 to 503 of the conveying guide 510 in the rotational axis direction are determined by the guide restricting portion 506a. Therefore, the conveying guide 510 can be incorporated into the main body frame 51 of which an inter-frame distance is fixed without having to flex the conveying guide 510.

In addition, in the conveying guide 510 according to the third embodiment, since positioning is performed using the end surfaces 505b and 505c of the end portions of the connecting member 505, the length of the connecting member 505 in the rotational axis direction is long and is less likely to be affected by heat.

### Fourth Embodiment

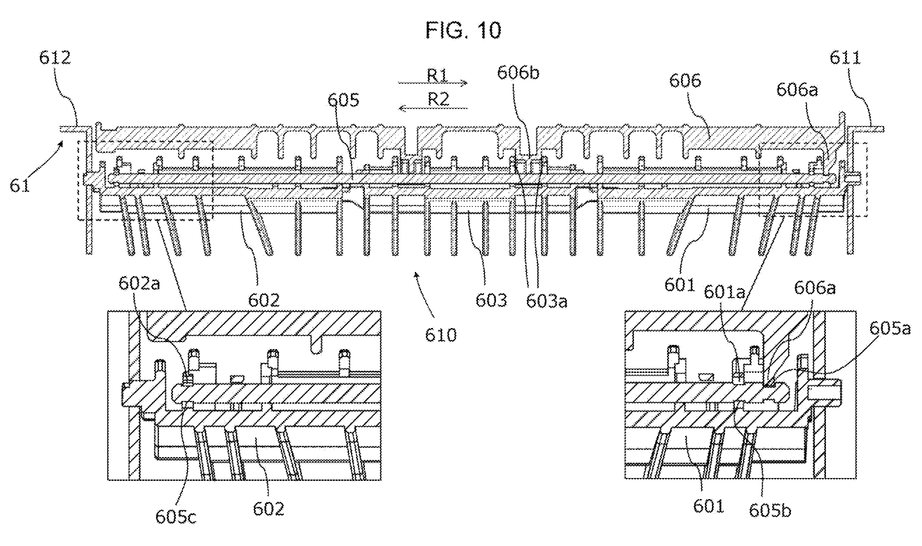

A conveying guide 610 according to a fourth embodiment will be described with reference to FIG. 10. FIG. 10 is a sectional view of the conveying guide 610 according to the fourth embodiment along a cross section parallel to the rotational axis direction. It should be noted that descriptions of portions that overlap with the description of the embodiments described above will not be repeated and different portions will be mainly described. Since a main body frame 61, a first frame 611, and a second frame 612 are similar to those according to the second embodiment, descriptions will not be repeated.

The conveying guide 610 includes a first guiding member 601, a second guiding member 602, and a third guiding member 603. A connecting member 605 is inserted through the guiding members 601 to 603. A stay member 606 is fixed so as to bridge between the first frame 611 and the second frame 612. The stay member 606 and the first frame 611 are fixed in a similar manner to the second embodiment.

In the second embodiment, a configuration has been described in which the guide restricting portion 306a provided in the stay member 306 positions the first guiding member 301 in the rotational axis direction. In the fourth embodiment, a guide restricting portion 606a provided in the stay member 606 positions the connecting member 605 in the rotational axis direction.

The connecting member 605 includes three groove portions, namely, a guide restricted portion 605a, a first groove portion 605b, and a second groove portion 605c. The stay member 606 includes the guide restricting portion 606a. The guide restricting portion 606a fits into the guide restricted portion 605a, and two surfaces that oppose each other to form the guide restricted portion 605a contact with the guide restricting portion 606a. In other words, the connecting member 605 and the stay member 606 contact with each other. Accordingly, the connecting member 605 is restricted from moving relative to the stay member 606 and the main body frame 61 in the first direction R1 and in the second direction R2. In other words, when the connecting member 605 receives an external force in the first direction R1 and when the connecting member 605 receives an external force in the second direction R2, one of the two end surfaces that form the guide restricted portion 605a contacts with the guide restricting portion 606a. In addition, the movement of the connecting member 605 with respect to the main body frame 61 is restricted. Each of the two surfaces that oppose each other to form the guide restricted portion 605a extends in a direction that intersects with the rotational axis direction. The guide restricting portion 606a extends in a direction that intersects with the rotational axis direction. The guide restricting portion 606a of the stay member 606 is a first restricting portion that restricts relative movement of the connecting member 605 with respect to the main body frame 61 in the first direction R1 and in the second direction R2 by contacting with the connecting member 605.

A first movement restricting portion 601a provided in the first guiding member 601 fits into the first groove portion 605b, and two surfaces that oppose each other to form the first groove portion 605b contact with the first movement restricting portion 601a. In other words, the connecting member 605 contacts with the first guiding member 601. Accordingly, the first guiding member 601 is restricted from moving relative to the connecting member 605 in the first direction R1 and in the second direction R2. In other words, when the connecting member 605 receives an external force in the first direction R1 and when the connecting member 605 receives an external force in the second direction R2, one of the two end surfaces that form the first groove portion 605b contacts with the first movement restricting portion 601a. In addition, the movement of the connecting member 605 with respect to the first guiding member 601 is restricted. Each of the two surfaces that oppose each other to form the first groove portion 605b extends in a direction that intersects with the rotational axis direction. The first movement restricting portion 601a extends in a direction that intersects with the rotational axis direction.

A second movement restricting portion 602a provided in the second guiding member 602 fits into the second groove portion 605c and the second groove portion 605c contacts with the second movement restricting portion 602a. In other words, the connecting member 605 contacts with the second guiding member 602. Accordingly, the second guiding member 602 is restricted from moving relative to the connecting member 605 in the first direction R1 and in the second direction R2. In other words, when the connecting member 605 receives an external force in the first direction R1 and when the connecting member 605 receives an external force in the second direction R2, one of the two end surfaces that form the second groove portion 605c contacts with the second movement restricting portion 602a. In addition, the movement of the connecting member 605 with respect to the second guiding member 602 is restricted. Each of the two surfaces that oppose each other to form the second groove portion 605c extends in a direction that intersects with the rotational axis direction. The second movement restricting portion 602a extends in a direction that intersects with the rotational axis direction.

When the first guiding member 601 receives an external force in the first direction R1, the first movement restricting portion 601a of the first guiding member 601 contacts with one of the two end surfaces that form the first groove portion 605b and an external force in the first direction R1 acts on the connecting member 605. In addition, one of the two end surfaces that form the guide restricted portion 605a of the connecting member 605 contacts with the guide restricting portion 606a and movement of the connecting member 605 is restricted. As a result, the first guiding member 601 is restricted from moving with respect to the main body frame 61 in the first direction R1. In this manner, when the first guiding member 601 receives an external force in the first direction R1, the first guiding member 601 contacts with the connecting member 605. In addition, the connecting member 605 contacts with the guide restricting portion 606a to restrict the first guiding member 601 from moving relative to the main body frame 61.

When the first guiding member 601 receives an external force in the second direction R2, the first movement restricting portion 601a of the first guiding member 601 contacts with the other of the two end surfaces that form the first groove portion 605b and an external force in the second direction R2 acts on the connecting member 605. In addition, the other of the two end surfaces that form the guide restricted portion 605a of the connecting member 605 contacts with the guide restricting portion 606a and movement of the connecting member 605 is restricted. As a result, the first guiding member 601 is restricted from moving with respect to the main body frame 61 in the second direction R2. In this manner, when the first guiding member 601 receives an external force in the second direction R2, the first guiding member 601 contacts with the connecting member 605. In addition, the connecting member 605 contacts with the guide restricting portion 606a to restrict the first guiding member 601 from moving relative to the main body frame 61.

When the second guiding member 602 receives an external force in the first direction R1, the second movement restricting portion 602a of the second guiding member 602 contacts with one of the two end surfaces that form the second groove portion 605c and an external force in the first direction R1 acts on the connecting member 605. In addition, one of the two end surfaces that form the guide restricted portion 605a of the connecting member 605 contacts with the guide restricting portion 606a and movement of the connecting member 605 is restricted. As a result, the second guiding member 602 is restricted from moving with respect to the main body frame 61 in the first direction R1. In this manner, when the second guiding member 602 receives an external force in the first direction R1, the second guiding member 602 contacts with the connecting member 605. In addition, the connecting member 605 contacts with the guide restricting portion 606a to restrict the second guiding member 602 from moving relative to the main body frame 61.

When the second guiding member 602 receives an external force in the second direction R2, the second movement restricting portion 602a of the second guiding member 602 contacts with the other of the two end surfaces that form the second groove portion 605c and an external force in the second direction R2 acts on the connecting member 605. In addition, the other of the two end surfaces that form the guide restricted portion 605a of the connecting member 605 contacts with the guide restricting portion 606a and movement of the connecting member 605 is restricted. As a result, the second guiding member 602 is restricted from moving with respect to the main body frame 61 in the second direction R2. In this manner, when the second guiding member 602 receives an external force in the second direction R2, the second guiding member 602 contacts with the connecting member 605. In addition, the connecting member 605 contacts with the guide restricting portion 606a to restrict the second guiding member 602 from moving relative to the main body frame 61.

The positioning of the third guiding member 603 in the rotational axis direction due to a third guide restricting portion 606b of the stay member 606 and a third guide restricted portion 603a of the third guiding member 603 is similar to the third embodiment.

In the configuration described above, the connecting member 605 is positioned in the rotational axis direction directly with respect to the stay member 606. Therefore, the configuration for positioning is simplified. In addition, variation in the position of the second guiding member 602 in the rotational axis direction due to thermal effects can be suppressed.

### Fifth Embodiment

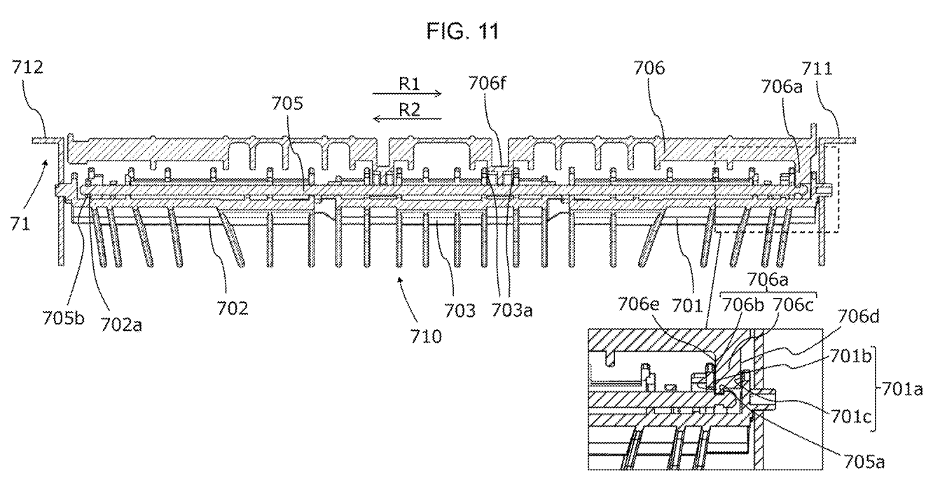

A conveying guide 710 according to a fifth embodiment will be described with reference to FIG. 11. FIG. 11 is a sectional view of the conveying guide 710 according to the fifth embodiment along a cross section parallel to the rotational axis direction. It should be noted that descriptions of portions that overlap with the description of the embodiments described above will not be repeated and different portions will be mainly described. Since a main body frame 71, a first frame 711, and a second frame 712 are similar to those according to the second embodiment, descriptions will not be repeated.

The conveying guide 710 includes a first guiding member 701, a second guiding member 702, and a third guiding member 703. A connecting member 705 is inserted through the guiding members 701 to 703. A stay member 706 is fixed so as to bridge between the first frame 711 and the second frame 712. The stay member 706 and the first frame 711 are fixed in a similar manner to the second embodiment.

The connecting member 705 includes a first groove portion 705a on one end side (right side in FIG. 11) and a second groove portion 705b on the other end side (left side in FIG. 11) in the rotational axis direction. The stay member 706 includes a guide restricting portion 706a. The guide restricting portion 706a includes a connecting member restricting portion 706b in a tip portion and a first guide restricting portion 706c in a root portion.

The connecting member restricting portion 706b fits into the first groove portion 705a, and two surfaces that oppose each other to form the first groove portion 705a contact with the connecting member restricting portion 706b. In other words, the connecting member 705 and the stay member 706 contact with each other. Accordingly, the connecting member 705 is restricted from moving relative to the stay member 706 and the main body frame 71 in the first direction R1 and in the second direction R2. In other words, when the connecting member 705 receives an external force in the first direction R1 and when the connecting member 705 receives an external force in the second direction R2, one of the two end surfaces that form the first groove portion 705a contacts with the connecting member restricting portion 706b. In addition, the movement of the connecting member 705 with respect to the stay member 706 is restricted. Each of the two surfaces that oppose each other to form the first groove portion 705a extends in a direction that intersects with the rotational axis direction. The connecting member restricting portion 706b extends in a direction that intersects with the rotational axis direction. The connecting member restricting portion 706b of the guide restricting portion 706a of the stay member 706 is a first restricting portion that restricts relative movement of the connecting member 705 with respect to the main body frame 71 in the first direction R1 and in the second direction R2 by contacting with the connecting member 705.

The first guiding member 701 includes a first guide restricted portion 701a, the first guide restricting portion 706c of the guide restricting portion 706a of the stay member 706 fits into the first guide restricted portion 701a, and the first guide restricting portion 706c contacts with the first guide restricted portion 701a. In other words, the first guiding member 701 and the stay member 706 contact with each other. Accordingly, the first guiding member 701 is restricted from moving relative to the stay member 706 and the first frame 711 in the first direction R1 and in the second direction R2. Accordingly, the first guiding member 701 is positioned with respect to the first frame 711 and the main body frame 71 in the rotational axis direction.

Specifically, the first guide restricting portion 706c includes an end surface 706d facing the first direction R1 and an end surface 706e facing the second direction R2. The end surface 706d and the end surface 706e extend in a direction that intersects with the rotational axis direction. The first guide restricted portion 701a includes an end surface 701b facing the first direction R1 and an end surface 701c facing the second direction R2. The end surface 701b and the end surface 701c extend in a direction that intersects with the rotational axis direction. The end surface 706d and the end surface 701c contact with each other to restrict the first guiding member 701 from moving relative to the stay member 706 and the main body frame 71 in the second direction R2. In other words, when the first guiding member 701 receives an external force in the second direction R2, the end surface 701c contacts with the end surface 706d, thereby restricting the movement of the first guiding member 701. The end surface 706e and the end surface 701b contact with each other to restrict the first guiding member 701 from moving relative to the stay member 706 and the main body frame 71 in the first direction R1. In other words, when the first guiding member 701 receives an external force in the first direction R1, the end surface 701b contacts with the end surface 706e, thereby restricting the movement of the first guiding member 701. The first guide restricting portion 706c of the guide restricting portion 706a of the stay member 706 is a first restricting portion that restricts relative movement of the first guiding member 701 with respect to the main body frame 71 in the first direction R1 and in the second direction R2 by contacting with the first guiding member 701.

A second movement restricting portion 702a provided in the second guiding member 702 fits into the second groove portion 705b and the second groove portion 705b contacts with the second movement restricting portion 702a. In other words, the connecting member 705 contacts with the second guiding member 702. Accordingly, the second guiding member 702 is restricted from moving relative to the connecting member 705 in the first direction R1 and in the second direction R2. In other words, when the connecting member 705 receives an external force in the first direction R1 and when the connecting member 705 receives an external force in the second direction R2, one of the two end surfaces that form the second groove portion 705b contacts with the second movement restricting portion 702a. In addition, the movement of the connecting member 705 with respect to the second guiding member 702 is restricted. Each of the two surfaces that oppose each other to form the second groove portion 705b extends in a direction that intersects with the rotational axis direction. The second movement restricting portion 702a extends in a direction that intersects with the rotational axis direction.

When the second guiding member 702 receives an external force in the first direction R1, the second movement restricting portion 702a of the second guiding member 702 contacts with one of the two end surfaces that form the second groove portion 705b and an external force in the first direction R1 acts on the connecting member 705. In addition, one of the two end surfaces that form the first groove portion 705a of the connecting member 705 contacts with the connecting member restricting portion 706b and movement of the connecting member 705 is restricted. As a result, the second guiding member 702 is restricted from moving with respect to the main body frame 71 in the first direction R1. In this manner, when the second guiding member 702 receives an external force in the first direction R1, the second guiding member 702 contacts with the connecting member 705. In addition, the connecting member 705 contacts with the connecting member restricting portion 706b to restrict the second guiding member 702 from moving relative to the main body frame 71.

When the second guiding member 702 receives an external force in the second direction R2, the second movement restricting portion 702a of the second guiding member 702 contacts with the other of the two end surfaces that form the second groove portion 705b and an external force in the second direction R2 acts on the connecting member 705. In addition, the other of the two end surfaces that form the first groove portion 705a of the connecting member 705 contacts with the connecting member restricting portion 706b and movement of the connecting member 705 is restricted. As a result, the second guiding member 702 is restricted from moving with respect to the main body frame 71 in the second direction R2. In this manner, when the second guiding member 702 receives an external force in the second direction R2, the second guiding member 702 contacts with the connecting member 705. In addition, the connecting member 705 contacts with the connecting member restricting portion 706b to restrict the second guiding member 702 from moving relative to the main body frame 71.

As described above, the second guiding member 702 is restricted from moving with respect to the main body frame 71 in the first direction R1 and in the second direction R2. In other words, when the second guiding member 702 receives an external force in the first direction R1 and when the second guiding member 702 receives an external force in the second direction R2, the second guiding member 702 contacts with the connecting member 705. In addition, the connecting member 705 contacts with the connecting member restricting portion 706b to restrict the movement of the second guiding member 702.

The positioning of the third guiding member 703 in the rotational axis direction due to a third guide restricting portion 706f of the stay member 706 and a third guide restricted portion 703a of the third guiding member 703 is similar to the third embodiment.

As described above, in the fifth embodiment, the guide restricting portion 706a provided in the stay member 706 positions both the first guiding member 701 and the connecting member 705 with respect to the stay member 706.

In the configuration described above, the first guiding member 701 is positioned in the rotational axis direction directly with respect to the stay member 706. Furthermore, in a similar manner to the fourth embodiment, the connecting member 705 is positioned in the rotational axis direction directly with respect to the stay member 706. Therefore, variation in the positions of the first guiding member 701 and the second guiding member 702 in the rotational axis direction due to thermal effects can be suppressed.

### Sixth Embodiment

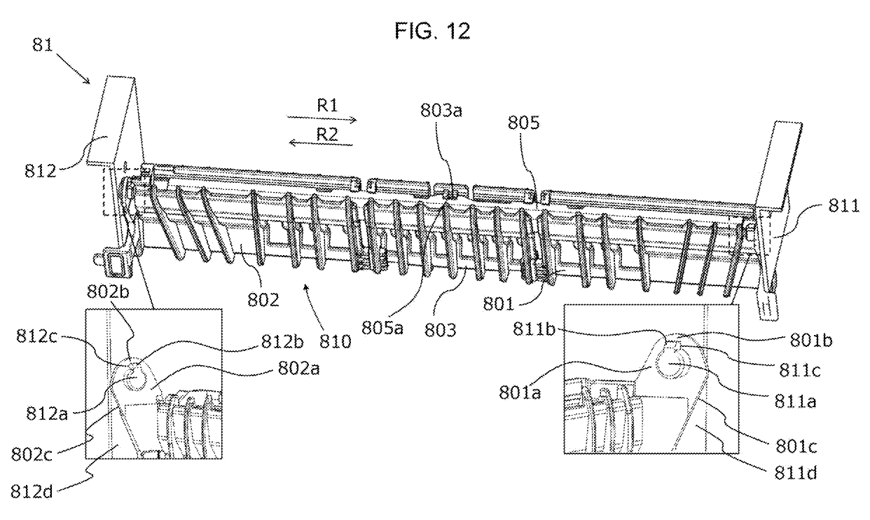

A conveying guide 810 according to a sixth embodiment will be described with reference to FIG. 12. FIG. 12 is a perspective view of the conveying guide 810 according to the sixth embodiment. It should be noted that descriptions of portions that overlap with the description of the embodiments described above will not be repeated and different portions will be mainly described.

The conveying guide 810 includes a first guiding member 801, a second guiding member 802, and a third guiding member 803. A connecting member 805 is inserted into a fitting hole which is provided in the guiding members 801 to 803 and which extends in the rotational axis direction, and restricts movement of the guiding members 801 to 803 in a direction orthogonal to the rotational axis direction. A main body frame 81 includes a first frame 811 and a second frame 812.

The first frame 811 includes a first engaging portion 811a and the second frame 812 includes a second engaging portion 812a. The conveying guide 810 is arranged sandwiched between the first frame 811 and the second frame 812 with respect to the rotational axis direction and rotatably supported by engaging with the first frame 811 and the second frame 812 at both end portions in the rotational axis direction. The conveying guide 810 includes a first engaged portion 801a that engages with the first engaging portion 811a of the first frame 811 and a second engaged portion 802a that engages with the second engaging portion 812a of the second frame 812. The first engaged portion 801a is provided in the first guiding member 801 and the second engaged portion 802a is provided in the second guiding member 802. The first engaged portion 801a engages with the first engaging portion 811a so as to be rotatable around an axis parallel to the rotational axis direction, and the second engaged portion 802a engages with the second engaging portion 812a so as to be rotatable around an axis parallel to the rotational axis direction.

The first engaging portion 811a includes a protruded portion 811b, and due to the first engaging portion 811a and the first engaged portion 801a engaging with each other, an end surface 811c of the protruded portion 811b facing the first direction R1 and an end surface 801b of the first engaged portion 801a facing the second direction R2 contact with each other. The end surface 811c and the end surface 801b extend in a direction that intersects with the rotational axis direction. Accordingly, the first guiding member 801 is restricted from moving relative to the first frame 811 in the second direction R2. In other words, when the first guiding member 801 receives an external force in the second direction R2, the end surface 801b contacts with the end surface 811c, thereby restricting the movement of the first guiding member 801. In addition, an end surface 801c of the first engaged portion 801a facing the first direction R1 and an end surface 811d of the first frame 811 facing the second direction R2 contact with each other. The end surface 811d and the end surface 801c extend in a direction that intersects with the rotational axis direction. Accordingly, the first guiding member 801 is restricted from moving relative to the first frame 811 in the first direction R1. In other words, when the first guiding member 801 receives an external force in the first direction R1, the end surface 801c contacts with the end surface 811d, thereby restricting the movement of the first guiding member 801.

The second engaging portion 812a includes a protruded portion 812b, and due to the second engaging portion 812a and the second engaged portion 802a engaging with each other, an end surface 812c of the protruded portion 812b facing the second direction R2 and an end surface 802b of the second engaged portion 802a facing the first direction R1 contact with each other. The end surface 812c and the end surface 802b extend in a direction that intersects with the rotational axis direction. Accordingly, the second guiding member 802 is restricted from moving relative to the second frame 812 in the first direction R1. In other words, when the second guiding member 802 receives an external force in the first direction R1, the end surface 802b contacts with the end surface 812c, thereby restricting the movement of the second guiding member 802. In addition, an end surface 802c of the second engaged portion 802a facing the second direction R2 and an end surface 812d of the second frame 812 facing the first direction R1 contact with each other. The end surface 812d and the end surface 802c extend in a direction that intersects with the rotational axis direction. Accordingly, the second guiding member 802 is restricted from moving relative to the second frame 812 in the second direction R2. In other words, when the second guiding member 802 receives an external force in the second direction R2, the end surface 802c contacts with the end surface 812d, thereby restricting the movement of the second guiding member 802.

In this manner, in the sixth embodiment, the first guiding member 801 is positioned with respect to the first frame 811 and the second guiding member 802 is positioned with respect to the second frame 812 in the rotational axis direction.

The third guiding member 803 includes a third movement restricting portion 803a. The connecting member 805 includes a depressed portion 805a. The third movement restricting portion 803a fits into the depressed portion 805a, and the third movement restricting portion 803a contacts with two end surfaces that oppose each other to form the depressed portion 805a. In other words, the third guiding member 803 contacts with the connecting member 805. Accordingly, the third guiding member 803 is restricted from moving relative to the connecting member 805 in the first direction R1 and in the second direction R2. In other words, when the connecting member 805 receives an external force in the first direction R1 and receives an external force in the second direction R2, one of the two end surfaces that form the depressed portion 805a contacts with the third movement restricting portion 803a and movement of the connecting member 805 is restricted. Each of the two end surfaces that oppose each other to form the depressed portion 805a extends in a direction that intersects with the rotational axis direction. The third movement restricting portion 803a extends in a direction that intersects with the rotational axis direction. On the other hand, the connecting member 805 does not include a positioning structure between the first guiding member 801 and the second guiding member 802. Therefore, the third guiding member 803 is movable relative to the first guiding member 801 and the second guiding member 802 in the first direction R1 and in the second direction R2. An amount of possible movement is determined by a gap between the first guiding member 801 and the third guiding member 803 and a gap between the second guiding member 802 and the third guiding member 803.

Note that a structure for positioning at least one of the first guiding member 801 and the second guiding member 802 with respect to the connecting member 805 in the rotational axis direction may be provided in a similar manner to the modification of the second embodiment. In addition, a configuration may be adopted in which, in a similar manner to the second embodiment and the like, a stay member is provided and the stay member is positioned with respect to the main body frame 81 by positioning the first guiding member 801 or the second guiding member 802 with respect to the stay member.

In the sixth embodiment, the first guiding member 801 is positioned with respect to the first frame 811 and the second guiding member 802 is positioned with respect to the second frame 812 in the rotational axis direction. Therefore, the thermal expansion coefficient of the material that forms the connecting member 805 need not be less than the thermal expansion coefficient of the material that forms the first guiding member 801 and the second guiding member 802 as in each of the embodiments described above. Even in such a case, variation in the positions of the guiding members 801 and 802 in the rotational axis direction due to thermal effects can be suppressed. Therefore, the connecting member 805 according to the sixth embodiment need not be made of metal. For example, the connecting member 805 can be formed of a same material as the material that forms the third guiding member 803. In this case, the connecting member 805 may be integrally formed with the third guiding member 803 in a shape that extends in the rotational axis direction from the third guiding member 803. Accordingly, the number of components can also be reduced.

### Seventh Embodiment

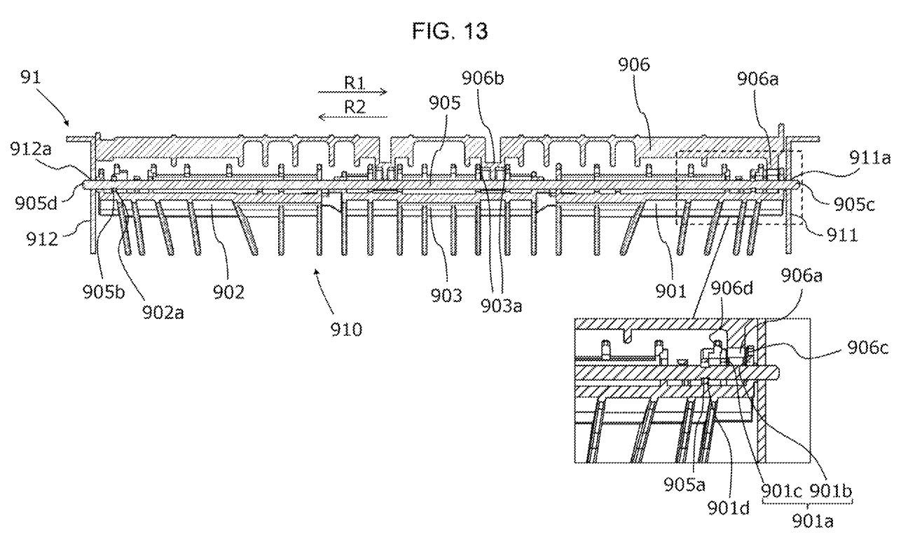

A conveying guide 910 according to a seventh embodiment will be described with reference to FIG. 13. FIG. 13 is a sectional view of the conveying guide 910 according to the seventh embodiment along a cross section parallel to the rotational axis direction. It should be noted that descriptions of portions that overlap with the description of the embodiments described above will not be repeated and different portions will be mainly described.

While configurations in which the first guiding member engages with the first frame and the second guiding member engages with the second frame have been described in the first to sixth embodiments, the configurations are not restrictive. For example, a member to engage with a frame may be a connecting member or a separate guiding member may be provided in both end portions of the conveying guide and the guiding members may engage with the frame. In the seventh embodiment, a configuration in which a connecting member 905 engages with a first frame 911 and a second frame 912 will be described.

The conveying guide 910 includes a first guiding member 901, a second guiding member 902, and a third guiding member 903. The connecting member 905 penetrates the guiding members 901 to 903 and protrudes from both ends of the conveying guide 910 in the rotational axis direction. A first end portion 905c of the connecting member 905 engages with a first engaging portion 911a of the first frame 911, and a second end portion 905d of the connecting member 905 engages with a second engaging portion 912a of the second frame 912. The first end portion 905c of the connecting member 905 is rotatably supported by the first engaging portion 911a of the first frame 911, and the second end portion 905d of the connecting member 905 is rotatably supported by the second engaging portion 912a of the second frame 912.

The connecting member 905 includes a first groove portion 905a on one end side (right side in FIG. 13) and a second groove portion 905b on the other end side (left side in FIG. 13) in the rotational axis direction.

A first movement restricting portion 901d provided in the first guiding member 901 fits into the first groove portion 905a, and two end surfaces that oppose each other to form the first groove portion 905a contact with the first movement restricting portion 901d. In other words, the connecting member 905 contacts with the first guiding member 901. Accordingly, the first guiding member 901 is restricted from moving relative to the connecting member 905 in the first direction R1 and in the second direction R2. In other words, when the connecting member 905 receives an external force in the first direction R1 and the connecting member 905 receives an external force in the second direction R2, one of the two end surfaces that oppose each other to form the first groove portion 905a contacts with the first movement restricting portion 901d and movement of the connecting member 905 is restricted. Each of the two end surfaces that oppose each other to form the first groove portion 905a extends in a direction that intersects with the rotational axis direction. The first movement restricting portion 901d extends in a direction that intersects with the rotational axis direction.

A second movement restricting portion 902a provided in the second guiding member 902 fits into the second groove portion 905b, and two end surfaces that oppose each other to form the second groove portion 905b contact with the second movement restricting portion 902a. In other words, the connecting member 905 contacts with the second guiding member 902. Accordingly, the second guiding member 902 is restricted from moving relative to the connecting member 905 in the first direction R1 and in the second direction R2. In other words, when the connecting member 905 receives an external force in the first direction R1 and the connecting member 905 receives an external force in the second direction R2, one of the two end surfaces that oppose each other to form the second groove portion 905b contacts with the second movement restricting portion 902a and movement of the connecting member 905 is restricted. Each of the two end surfaces that oppose each other to form the second groove portion 905b extends in a direction that intersects with the rotational axis direction. The second movement restricting portion 902a extends in a direction that intersects with the rotational axis direction.

The positioning of the third guiding member 903 in the rotational axis direction due to a third guide restricting portion 906b of a stay member 906 and a third guide restricted portion 903a of the third guiding member 903 is similar to the third embodiment.

The first guiding member 901 includes a first guide restricted portion 901a, a first guide restricting portion 906a of the stay member 906 fits into the first guide restricted portion 901a, and the first guide restricting portion 906a contacts with the first guide restricted portion 901a. In other words, the first guiding member 901 and the stay member 906 contact with each other. Accordingly, the first guiding member 901 is restricted from moving relative to the stay member 906 and the first frame 911 in the first direction R1 and in the second direction R2. Accordingly, the first guiding member 901 is positioned with respect to the first frame 911 in the rotational axis direction.

Specifically, the first guide restricting portion 906a includes an end surface 906c facing the first direction R1 and an end surface 906d facing the second direction R2. The end surface 906c and the end surface 906d extend in a direction that intersects with the rotational axis direction. The first guide restricted portion 901a includes an end surface 901c facing the first direction R1 and an end surface 901b facing the second direction R2. The end surface 901c and the end surface 901b extend in a direction that intersects with the rotational axis direction. The end surface 906c and the end surface 901b contact with each other to restrict the first guiding member 901 from moving relative to the stay member 906 in the second direction R2. In other words, when the first guiding member 901 receives an external force in the second direction R2, the end surface 901b contacts with the end surface 906c, thereby restricting the movement of the first guiding member 901. The end surface 906d and the end surface 901c contact with each other to restrict the first guiding member 901 from moving relative to the stay member 906 in the first direction R1. In other words, when the first guiding member 901 receives an external force in the first direction R1, the end surface 901c contacts with the end surface 906d, thereby restricting the movement of the first guiding member 901.

As described above, the connecting member 905 is restricted from moving relative to the first guiding member 901 in the first direction R1 and in the second direction R2. In addition, as described above, the first guiding member 901 is restricted from moving relative to a main body frame 91 in the first direction R1 and in the second direction R2. Therefore, the connecting member 905 is restricted from moving relative to the main body frame 91 in the first direction R1 and in the second direction R2.

When the second guiding member 902 receives an external force in the first direction R1, the second movement restricting portion 902a of the second guiding member 902 contacts with one of the two end surfaces that form the second groove portion 905b and an external force in the first direction R1 acts on the connecting member 905. In addition, one of the two end surfaces that form the first groove portion 905a of the connecting member 905 contacts with the first movement restricting portion 901d and an external force in the first direction R1 acts on the first guiding member 901. In addition, the end surface 901c of the first guiding member 901 contacts with the end surface 906d of the first guide restricting portion 906a, thereby restricting the movement of the first guiding member 901. As a result, the second guiding member 902 is restricted from moving with respect to the main body frame 91 in the first direction R1.

When the second guiding member 902 receives an external force in the second direction R2, the second movement restricting portion 902a of the second guiding member 902 contacts with the other of the two end surfaces that form the second groove portion 905b and an external force in the second direction R2 acts on the connecting member 905. In addition, the other of the two end surfaces that form the first groove portion 905a of the connecting member 905 contacts with the first movement restricting portion 901d and an external force in the second direction R2 acts on the first guiding member 901. In addition, the end surface 901b of the first guiding member 901 contacts with the end surface 906c of the first guide restricting portion 906a, thereby restricting the movement of the first guiding member 901. As a result, the second guiding member 902 is restricted from moving with respect to the main body frame 91 in the second direction R2.

As described above, the second guiding member 902 is restricted from moving with respect to the main body frame 91 in the first direction R1 and in the second direction R2. In other words, when the second guiding member 902 receives an external force in the first direction R1 and receives an external force in the second direction R2, the second guiding member 902 contacts with the connecting member 905. In addition, the connecting member 905 contacts with the first guiding member 901 and the first guiding member 901 contacts with the first guide restricting portion 906a to restrict the movement of the second guiding member 902.

According to the seventh embodiment, even in a configuration in which the connecting member 905 engages with the first frame 911 and the second frame 912 in both end portions of the connecting member 905, the positions of the first guiding member 901 and the second guiding member 902 are less susceptible to thermal effects. Therefore, a similar effect to that of the embodiments described above can be produced.

The present disclosure serves to improve positioning accuracy in a rotational axis direction of a plurality of components that constitute a conveying guide.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-017967, filed February 5, 2025, which is hereby incorporated by reference herein in its entirety.

What is claimed is:

1. A conveying apparatus configured to convey a recording material, the conveying apparatus comprising:
a conveying roller configured to convey the recording material;
a main body frame that includes a first frame including a first engaging portion and a second frame including a second engaging portion;
a conveying guide arranged between the first frame and the second frame in a rotational axis direction of the conveying roller, the conveying guide including a first guiding member and a second guiding member configured to guide the recording material, and including a first engaged portion that engages with the first engaging portion and a second engaged portion that engages with the second engaging portion; and
a connecting member connecting the first guiding member and the second guiding member,
wherein:
the first guiding member and the second guiding member are arranged side by side in the rotational axis direction such that the first guiding member is closer to the first frame than to the second frame and the second guiding member is closer to the second frame than to the first frame in the rotational axis direction;
a thermal expansion coefficient of the connecting member is less than a thermal expansion coefficient of the first guiding member and less than a thermal expansion coefficient of the second guiding member;
where a first direction is a direction parallel to the rotational axis direction and oriented from the second frame toward the first frame, and a second direction is a direction opposite to the first direction,
the connecting member is restricted from moving relative to the main body frame in the first direction and in the second direction; and
the second guiding member is restricted from moving relative to the connecting member in the first direction and in the second direction.

2. The conveying apparatus according to claim 1, the conveying apparatus further comprising:
a first restricting portion,
wherein the first restricting portion is configured to restrict the first guiding member from moving relative to the main body frame in at least one of the first direction and the second direction.

3. The conveying apparatus according to claim 2, wherein:
in the rotational axis direction, the first guiding member includes one end and the other end, and the one end is closer to the first frame than the other end is; and
in the rotational axis direction, the first restricting portion is closer to the one end than to the other end.

4. The conveying apparatus according to claim 3, wherein
the first restricting portion is configured to restrict the first guiding member from moving relative to the main body frame in the first direction and in the second direction.

5. The conveying apparatus according to claim 4, wherein
the first restricting portion is configured to contact with the first guiding member to restrict the first guiding member from moving relative to the main body frame in the first direction and in the second direction.

6. The conveying apparatus according to claim 5, wherein
the connecting member is configured to contact with the first guiding member to be restricted from moving relative to the first guiding member in the first direction and in the second direction.

7. The conveying apparatus according to claim 5, wherein
the first restricting portion is configured to contact with the connecting member to restrict the connecting member from moving relative to the main body frame in the first direction and in the second direction.

8. The conveying apparatus according to claim 4, wherein:
the first restricting portion is configured to contact with the first guiding member to restrict the first guiding member from moving relative to the main body frame in the second direction;
the first restricting portion is configured to contact with the connecting member to restrict the connecting member from moving relative to the main body frame in the first direction; and
the first guiding member is configured to contact with the connecting member to be restricted from moving relative to the connecting member in the first direction.

9. The conveying apparatus according to claim 4, wherein:
the first restricting portion is configured to contact with the connecting member to restrict the connecting member from moving relative to the main body frame in the first direction and in the second direction; and
the first guiding member is configured to contact with the connecting member to be restricted from moving relative to the connecting member in the first direction and in the second direction.

10. The conveying apparatus according to claim 2, wherein:
the first frame includes the first restricting portion;
the second frame includes a second restricting portion;
the first restricting portion is configured to contact with the first guiding member to restrict the first guiding member from moving relative to the main body frame in the first direction; and
the second restricting portion is configured to contact with the second guiding member to restrict the second guiding member from moving relative to the main body frame in the second direction.

11. A conveying apparatus configured to convey a recording material, the conveying apparatus comprising:
a conveying roller configured to convey the recording material;
a main body frame that includes a first frame including a first engaging portion and a second frame including a second engaging portion;
a conveying guide arranged between the first frame and the second frame in a rotational axis direction of the conveying roller, the conveying guide including a first guiding member and a second guiding member configured to guide the recording material, and including a first engaged portion that engages with the first engaging portion and a second engaged portion that engages with the second engaging portion; and
a connecting member connecting the first guiding member and the second guiding member,
wherein:
the first guiding member and the second guiding member are arranged side by side in the rotational axis direction such that the first guiding member is closer to the first frame than to the second frame and the second guiding member is closer to the second frame than to the first frame in the rotational axis direction;
where a first direction is a direction parallel to the rotational axis direction and oriented from the second frame toward the first frame, and a second direction is a direction opposite to the first direction,
the first engaging portion and the first engaged portion engage with each other to restrict the first guiding member from moving relative to the first frame in the second direction; and
the second engaging portion and the second engaged portion engage with each other to restrict the second guiding member from moving relative to the second frame in the first direction.

12. The conveying apparatus according to claim 1, wherein:
the conveying guide includes a third guiding member configured to guide the recording material; and
the third guiding member is arranged between the first guiding member and the second guiding member in the rotational axis direction.

13. The conveying apparatus according to claim 12, wherein
the third guiding member is restricted from moving relative to the main body frame in the first direction and in the second direction.

14. The conveying apparatus according to claim 12, wherein
the third guiding member is restricted from moving relative to the connecting member in the first direction and in the second direction.

15. The conveying apparatus according to claim 1, wherein:
the first engaged portion engages with the first engaging portion so as to be rotatable around an axis parallel to the rotational axis direction; and
the second engaged portion engages with the second engaging portion so as to be rotatable around an axis parallel to the rotational axis direction.

16. The conveying apparatus according to claim 1, the conveying apparatus further comprising:
a transferring device configured to transfer a toner image to the recording material; and
a fixing device configured to heat the recording material such that the toner image having been transferred by the transferring device is fixed on the recording material,
wherein the conveying guide is configured to guide the recording material on a downstream side of the fixing device in a conveying path of the recording material.

17. The conveying apparatus according to claim 1, wherein
the conveying roller is rotatably supported by the main body frame.

18. The conveying apparatus according to claim 1, wherein:
the conveying guide is formed of a resin; and
the connecting member is formed of a metal.

19. The conveying apparatus according to claim 18, wherein
the resin is polyacetal.

20. The conveying apparatus according to claim 1, wherein:
the conveying guide includes a plurality of ribs for guiding the recording material; and
positions of the plurality of ribs differ from each other in the rotational axis direction.
